(19) United States
(12) Patent Application Publication
(10) Pub. No.: US 2026/0362434 A1
(43) Pub. Date: Nov. 12, 2026

(54) DOWNLINK REFERENCE SIGNAL REPORTING WITH REDUCED OVERHEAD USING BEAM-INDEPENDENT REFERENCE VALUES

(71) Applicant: QUALCOMM Incorporated, San Diego, CA (US)

(72) Inventors: Qiaoyu LI, Beijing (CN); Mahmoud TAHERZADEH BOROUJENI, San Diego, CA (US); Tao LUO, San Diego, CA (US)

(21) Appl. No.: 19/487,974

(22) PCT Filed: Jul. 26, 2023
(86) PCT No.: PCT/CN2023/109259

§ 371 Date: Nov. 25, 2025

(51) Int. Cl. H04W 72/21; H04B 17/318

(52) U.S. Cl. CPC H04W 72/21; H04B 17/328

(57) ABSTRACT

Systems and techniques are provided for wireless communications. A user equipment (UE) can receive information indicative of a plurality of channel resources and can determine a respective reference value for each channel resource group of one or more channel resource groups. Each channel resource group of the one or more channel resource groups can include at least a subset of the plurality of channel resources. The UE can transmit uplink information to a network entity, wherein the uplink information is indicative of the respective reference value for each channel resource group of the one or more channel resource groups, and respective measurement information indicative of one or more differential values relative to the respective reference value for each channel resource group of the one or more channel resource groups.

### FIELD

The present disclosure generally relates to wireless communications. For example, aspects of the present disclosure relate to systems and techniques for overhead reduction in L1 reporting for downlink reference signals.

### BACKGROUND

Wireless communications systems are deployed to provide various telecommunications and data services, including telephony, video, data, messaging, and broadcasts. Broadband wireless communications systems have developed through various generations, including a first-generation analog wireless phone service (1G), a second-generation (2G) digital wireless phone service (including interim 2.5G networks), a third-generation (3G) high speed data, Internet-capable wireless device, and a fourth-generation (4G) service (e.g., Long-Term Evolution (LTE), WiMax). Examples of wireless communications systems include code division multiple access (CDMA) systems, time division multiple access (TDMA) systems, frequency division multiple access (FDMA) systems, orthogonal frequency division multiple access (OFDMA) systems, Global System for Mobile communication (GSM) systems, etc. Other wireless communications technologies include 802.11 Wi-Fi, Bluetooth, among others.

A fifth-generation (5G) mobile standard calls for higher data transfer speeds, greater number of connections, and better coverage, among other improvements. The 5G standard (also referred to as “New Radio” or “NR”), according to Next Generation Mobile Networks Alliance, is designed to provide data rates of several tens of megabits per second to each of tens of thousands of users, with 1 gigabit per second to tens of workers on an office floor. Several hundreds of thousands of simultaneous connections should be supported in order to support large sensor deployments.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some examples, downlink (DL) beam management (BM) can be performed to determine and/or select an optimal beam from a plurality of beams. In some cases, a user equipment (UE) can generate and transmit a Layer 1 (L1) (e.g., physical layer) measurement report on an uplink (UL) from the UE to a network device (e.g., a base station). Based on receiving the L1 measurement report from the UE, the network device can determine information associated with one or more reference signal received power (RSRP) value and/or a signal-to-interference-plus noise (SINR) values (e.g., L1-RSRP or L1-SINR values) measured by the UE and perform DL beam management to select a best or optimal beam for subsequent transmissions.

In some cases, DL beam management can be performed based on at least one demodulation reference signal (DMRS). For example, a network device (e.g., a base station) can transmit multiple DMRSs in different directions and using different beams or resources. A UE can measure an RSRP and/or SINR value and generate an L1 measurement report indicative of the DMRS measurement information determined at the UE.

Transmitting L1 measurement reports can be associated with a large signaling overhead (e.g., between the UE and one or more base stations). In some cases, there is a need to reduce UL signaling overhead associated with transmitting L1 measurement reports and/or associated with performing DL beam management. In some aspects, there is an additional need to reduce UL signaling overhead associated with performing DL beam management based on one or more DMRSs. In some cases, there is a further need to reduce UL signaling overhead associated with transmitting L1 measurements reports for beam prediction. In some aspects, there is also a need to reduce UL signaling overhead associated with transmitting L1 measurement reports associated with beam prediction performed by a network entity, such as where the L1 measurement reports correspond to measurement feedback information of a reference signal received by the UE or correspond to predicted measurement feedback information of a virtual reference signal simulated by the UE using configured virtual resources.

Systems and techniques are described herein that can be used to generate a beam measurement information report with a reduced UL signaling overhead. For instance, the systems and techniques can be used to generate beam measurement information corresponding to one or more beam prediction use cases at a network entity (e.g., a base station) that receives the beam measurement information report from the UE. In some cases, the beam measurement information report with a reduced UL signaling overhead can be generated based on one or more common reference values.

According to at least one illustrative example, a method of wireless communication performed at a user equipment (UE) is provided. The method includes: receiving information indicative of a plurality of channel resources; determining a respective reference value for each channel resource group of one or more channel resource groups, wherein each channel resource group of the one or more channel resource groups includes at least a subset of the plurality of channel resources; and transmitting uplink information, wherein the uplink information is indicative of: the respective reference value for each channel resource group of the one or more channel resource groups; and respective measurement information indicative of one or more differential values relative to the respective reference value for each channel resource group of the one or more channel resource groups.

In another illustrative example, an apparatus of a user equipment (UE) for wireless communication is provided. The apparatus includes at least one memory and at least one processor coupled to the at least one memory and configured to: receive information indicative of a plurality of channel resources; determine a respective reference value for each channel resource group of one or more channel resource groups, wherein each channel resource group of the one or more channel resource groups includes at least a subset of the plurality of channel resources; and transmit uplink information, wherein the uplink information is indicative of: the respective reference value for each channel resource group of the one or more channel resource groups; and respective measurement information indicative of one or more differential values relative to the respective reference value for each channel resource group of the one or more channel resource groups.

In another illustrative example, a non-transitory computer-readable storage medium comprising instructions stored thereon which, when executed by at least one processor, causes the at least one processor to: receive information indicative of a plurality of channel resources; determine a respective reference value for each channel resource group of one or more channel resource groups, wherein each channel resource group of the one or more channel resource groups includes at least a subset of the plurality of channel resources; and transmit uplink information, wherein the uplink information is indicative of: the respective reference value for each channel resource group of the one or more channel resource groups; and respective measurement information indicative of one or more differential values relative to the respective reference value for each channel resource group of the one or more channel resource groups.

In another illustrative example, an apparatus is provided for wireless communication. The apparatus includes: means for receiving information indicative of a plurality of channel resources; means for determining a respective reference value for each channel resource group of one or more channel resource groups, wherein each channel resource group of the one or more channel resource groups includes at least a subset of the plurality of channel resources; and means for transmitting uplink information, wherein the uplink information is indicative of: the respective reference value for each channel resource group of the one or more channel resource groups; and respective measurement information indicative of one or more differential values relative to the respective reference value for each channel resource group of the one or more channel resource groups.

In another illustrative example, a method of wireless communication performed at a network entity is provided. The method includes: transmitting information indicative of a plurality of channel resources; and receiving uplink information from a user equipment (UE), wherein the uplink information is indicative of: a respective reference value for each channel resource group of one or more channel resource groups, wherein each channel resource group of the one or more channel resource groups includes at least a subset of the plurality of channel resources; and respective measurement information indicative of one or more differential values relative to the respective reference value for each channel resource group of the one or more channel resource groups.

In another illustrative example, an apparatus of a network entity for wireless communication is provided. The apparatus includes at least one memory and at least one processor coupled to the at least one memory and configured to: transmit information indicative of a plurality of channel resources; and receive uplink information from a user equipment (UE), wherein the uplink information is indicative of: a respective reference value for each channel resource group of one or more channel resource groups, wherein each channel resource group of the one or more channel resource groups includes at least a subset of the plurality of channel resources; and respective measurement information indicative of one or more differential values relative to the respective reference value for each channel resource group of the one or more channel resource groups.

In another illustrative example, a non-transitory computer-readable storage medium comprising instructions stored thereon which, when executed by at least one processor, causes the at least one processor to: transmit information indicative of a plurality of channel resources; and receive uplink information from a user equipment (UE), wherein the uplink information is indicative of: a respective reference value for each channel resource group of one or more channel resource groups, wherein each channel resource group of the one or more channel resource groups includes at least a subset of the plurality of channel resources; and respective measurement information indicative of one or more differential values relative to the respective reference value for each channel resource group of the one or more channel resource groups.

In another illustrative example, an apparatus is provided for wireless communication. The apparatus includes: means for transmitting information indicative of a plurality of channel resources; and means for receiving uplink information from a user equipment (UE), wherein the uplink information is indicative of: a respective reference value for each channel resource group of one or more channel resource groups, wherein each channel resource group of the one or more channel resource groups includes at least a subset of the plurality of channel resources; and respective measurement information indicative of one or more differential values relative to the respective reference value for each channel resource group of the one or more channel resource groups.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip examples or implementations, or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description.

### BRIEF DESCRIPTION OF THE DRAWINGS

Examples of various implementations are described in detail below with reference to the following figures:

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples;

FIG. 3 is a diagram illustrating an example of a disaggregated base station, in accordance with some examples;

FIG. 4 is a block diagram illustrating components of a user equipment, in accordance with some examples;

FIG. 5 is a diagram illustrating an example of physical channels and reference signals in a wireless network, in accordance with some examples;

FIG. 6 is a diagram illustrating an example of a plurality of synchronization signal blocks (SSBs) and a beam-independent reference value, in accordance with some examples;

FIG. 7 is a diagram illustrating an example of a measurement report indicative of a beam-independent reference value and a plurality of differential values relative to the beam-independent reference value, in accordance with some examples;

FIG. 8 is a diagram illustrating a plurality of SSB segments each associated with a respective beam-independent reference value, in accordance with some examples;

FIG. 9 is a diagram illustrating an example of a measurement report indicative of a plurality of beam-independent reference values and for each respective beam-independent reference value a corresponding plurality of differential values relative to the respective beam-independent reference value, in accordance with some examples;

FIG. 10 is a flow diagram illustrating example processes for wireless communication, in accordance with some examples;

FIG. 11 is a flow diagram illustrating an example process for wireless communication by a network entity, in accordance with some examples;

FIG. 12 is a signaling diagram corresponding to a process of wireless communication between a network entity and a user equipment (UE), in accordance with some examples; and

FIG. 13 is a block diagram illustrating an example of a computing system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, reference signals are transmitted and received via beams. In some examples, a beam may be generated using beamforming. Beamforming (e.g., which may also be referred to as spatial filtering, directional transmission, and/or directional reception) is a signal processing technique that may be used at a transmitting device or a receiving device (e.g., a base station or a UE) to shape or steer an antenna beam (e.g., a transmit beam or receive beam) along a spatial path between the transmitting device and the receiving device. Beamforming can be performed based on combining signals communicated via antenna elements of an antenna array such that signals propagating at particular orientations with respect to an antenna array experience constructive interference while others experience destructive interference. The adjustment of signals communicated via the antenna elements may include a transmitting device or a receiving device applying certain amplitude and phase offsets to signals carried via each of the antenna elements associated with the transmitting device or receiving device. The adjustments associated with each of the antenna elements may be defined by a beamforming weight set associated with a particular orientation (e.g., with respect to the antenna array of the transmitting device or receiving device, or with respect to some other orientation).

In some examples, a base station may use multiple antennas or antenna arrays to conduct beamforming operations for directional communications with a UE. For example, one or more signals (e.g., synchronization signals, reference signals, beam management signals, and/or other control signals) may be transmitted by a base station multiple times in different directions, which may include a signal being transmitted according to different beamforming weight sets associated with different directions of transmission. Transmissions in different beam directions may be used to identify (e.g., by the base station or a receiving device (e.g., a UE)) a beam direction for subsequent transmission and/or reception by the base station. Some signals (e.g., such as data signals associated with a particular receiving device) may be transmitted by a base station in a single beam direction (e.g., a direction associated with the receiving device or UE). In some examples, the beam direction associated with transmissions along a single beam direction may be determined based on a signal that was transmitted in different beam directions. For example, a UE may receive one or more of the signals transmitted by the base station in different directions, and the UE may report to the base station an indication of the signal that the UE received with a highest signal quality. In some cases, the UE may report to the base station an indication of multiple signals received by the UE, along with an associated signal quality with which the UE received each respective signal of the multiple signals.

In some examples, downlink (DL) beam management (BM) can be performed to determine and/or select an optimal beam from a plurality of beams. For example, in 5G NR, DL beam management may be performed based on synchronization signal block (SSB) measurements and/or channel state information (CSI) reference signal (CSI-RS) measurements. A base station (e.g., gNB) can transmit multiple beams or resources in different directions and a UE can measure some (or all) of the beams transmitted by the base station. Each beam measured by the UE can be associated with a measurement value. For example, the UE can measure a reference signal received power (RSRP) value and/or a signal-to-interference-plus noise (SINR) value, among others.

In some cases, the UE can generate and transmit a Layer 1 (L1) (e.g., physical layer) measurement report on an uplink (UL) from the UE to the base station. An uplink channel may include a physical uplink control channel (PUCCH) that carries uplink control information (UCI), a physical uplink shared channel (PUSCH) that carries uplink data, or a physical random access channel (PRACH) used for initial network access, among other examples. In some examples, an L1 measurement report can include SSB and/or CSI-RS measurements (e.g., RSRP and/or SINR values) measured by the UE for corresponding SSB and/or CSI-RS beams or resources transmitted by the base station. The L1 measurement report can be transmitted on the uplink channel associated with the UE (e.g., on PUCCH or PUSCH). Based on receiving the L1 measurement report from the UE, the base station can determine information associated with one or more L1-RSRP or L1-SINR values measured by the UE and perform DL beam management to select a best or optimal beam for subsequent transmissions.

In some cases, DL beam management can be performed based on at least one demodulation reference signal (DMRS). For example, a base station (e.g., gNB) can transmit multiple DMRSs in different directions and using different beams or resources. A UE can measure an RSRP and/or SINR value and generate an L1 measurement report indicative of the DMRS measurement information determined at the UE. In some examples, mixed beam DL beam management can be performed based on a combination of DMRSs, SSBs, and/or CSI-RSs, wherein a UE measures an RSRP and/or SINR value for each respective DMRS, SSB, and/or CSI-RS beam or resource. An L1 measurement report can be generated indicative of the mixed beam measurement information determined at the UE and can subsequently be utilized to performed mixed beam DL beam management.

Transmitting L1 measurement reports can be associated with a large signaling overhead (e.g., between the UE and one or more base stations). For example, in some cases, an L1 measurement report may include 7 bits for the strongest measurements and 4 bits for each of the 3 remaining measurements (e.g., indicating a differential with regard to the strongest measurement). In some examples, multiple measurement reports (e.g., based on multiple reporting settings) may be sent in a single PUCCH or PUSCH. For example, the number of measurement reports that can be transmitted in a single PUCCH or PUSCH may be limited by the PUCCH/PUSCH payload size. If the payload size is not sufficient, then one or more measurements reports with a lowest priority may be dropped.

There is a need to reduce UL signaling overhead associated with transmitting L1 measurement reports and/or associated with performing DL beam management. In some cases, there is an additional need to reduce UL signaling overhead associated with performing DL beam management based on one or more DMRSs. There is a further need to reduce UL signaling overhead associated with transmitting L1 measurements reports for beam prediction. In beam prediction, a network entity (e.g., a base station, such as a gNB, eNB, etc.) can use one or more artificial intelligence (AI) and/or machine learning (ML) models to perform beam management based on beam prediction feedback information transmitted from a UE to the gNB. For instance, spatial-domain DL beam prediction can be performed for a first set of beams based on measurement results determined by the UE for a second set of beams. In another example, temporal-domain DL beam prediction can be performed for a first set of beams based on historical measurement results determined by the UE for the first set of beams at an earlier time. There is a need to reduce UL signaling overhead associated with transmitting L1 measurement reports associated with beam prediction performed by a network entity, where the L1 measurement reports correspond to measurement feedback information of a reference signal received by the UE or correspond to predicted measurement feedback information of a virtual reference signal simulated by the UE using configured virtual resources.

Systems, apparatuses, processes (also referred to as methods), and computer-readable media (collectively referred to as “systems and techniques”) are described herein that can be used to generate a beam measurement information report with a reduced UL signaling overhead. For instance, the systems and techniques can be used to generate beam measurement information corresponding to one or more beam prediction use cases at a network entity (e.g., gNB, base station, etc.) that receives the beam measurement information report from the UE. In some cases, the beam measurement information report with a reduced UL signaling overhead can be generated based on one or more common reference values. For instance, the beam measurement information report can be indicative of one or more L1 reference signal received power (RSRP) values and/or one or more L1 signal-to-interference-plus noise (SINR) values. The reduced UL signaling overhead can be based on determining one or more common reference L1-RSRP or SINR values and reporting each common reference L1-RSRP or SINR value using a first quantity of bits. The first quantity of bits can be the quantity of bits used to report the full value of the L1-RSRP or SINR. A plurality of additional L1-RSRP or SINR values can be indicated in the reduced overhead beam measurement information report based on differential signaling. For example, each additional L1-RSRP or SINR value can be indicated in the beam measurement information report using a second quantity of bits that is less than the first quantity of bits used to report the common reference L1-RSRP or SINR value. For example, a common reference L1-RSRP or SINR value can be reported using seven bits, and the additional L1-RSRP or SINR values can each be reported using two bits.

In one illustrative example, the each additional L1-RSRP or SINR value can be indicated using differential reporting relative to a corresponding common reference L1-RSRP or SINR value. In some cases, the differential reporting can be based on a differential quantization of the additional L1-RSRP or SINR values relative to the common reference L1-RSRP or SINR value(s). The differential quantization can include +dB values (e.g., differential values indicative of an amount or range by which a particular one of the additional L1-RSRP/SINR values exceeds the common reference L1-RSRP/SINR value) and can include-dB values (e.g., differential values indicative of an amount or range by which a particular one of the additional L1-RSRP/SINR values is less than the common reference L1-RSRP/SINR value). In some aspects, the UL signaling overhead associated with the beam measurement information report can be further reduced by not addressing any beam identification (beam-ID) information in the beam measurement information report. For instance, a beam measurement information report for 32 beams can be generated to include 7 bits for a common L1-RSRP/SINR reference value and 2*31=62 bits for the plurality of differential quantized additional L1-RSRP/SINR values. The total beam measurement information report bit quantity of 69 bits may represent an approximately 50% reduction in UL signaling overhead.

In some cases, the reduced UL signaling overhead beam measurement information reports can be associated with data collection for training one or more beam prediction AI or ML models at a network entity and/or can be associated with data collection for performing inference using one or more beam prediction AI or ML models at a network entity. AI and ML models utilize large quantities of data during training, and in some cases performance during inference may be improved based on providing a larger quantity of input data. Based on reducing the UL signaling overhead associated with L1 beam measurement information reports generated by a UE, the systems and techniques can be used to increase the amount of beam measurement information reports that can be received by a network entity using the same number of bits. Additionally, reducing the UL signaling overhead associated with L1 beam measurement information reports generated by a UE can allow a network entity to receive beam measurement information at an increased rate per unit time.

In some cases, the beam measurement information report can correspond to a downlink reference signal that is transmitted by a network entity and received by a UE. For instance, the beam measurement information report can correspond to one or more channel measurement resources (CMRs) associated with at least one reference signal. CMRs can include synchronization signal blocks (SSBs), Channel State Information (CSI) Reference Signals (CSI-RSs), etc. In some examples, the beam measurement information report can correspond to a virtual reference signal that is not actually transmitted by a network entity and is not actually received by a UE. For instance, a network entity may configure a UE to predict the RSRP or SINR associated with receiving a reference signal (or other signal) using a particular one or more channel resources. The network entity can indicate to the UE the channel resource(s) information for the configured prediction, and the UE can generate the beam measurement information report to be indicative of the predicted RSRP or SINR values for the configured channel resources. In some aspects, the beam measurement information report can correspond to one or more channel prediction resources (CPRs) associated with at least one reference signal (e.g., where the at least one reference signal is a virtual reference signal or virtual signal). In some cases, CPRs can also be referred to as virtual resources or virtual channel resources not actually transmitted by the network entity or received by the UE.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs may communicate with a core network via a RAN, and through the core network the UEs may be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.) and so on.

A network entity may be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs may send signals to a base station is called an uplink (UL) channel (e.g., a reverse traffic channel, a reverse control channel, an access channel, etc.). A communication link through which the base station may send signals to UEs is called a downlink (DL) or forward link channel (e.g., a paging channel, a control channel, a broadcast channel, or a forward traffic channel, etc.). The term traffic channel (TCH), as used herein, may refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals (or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

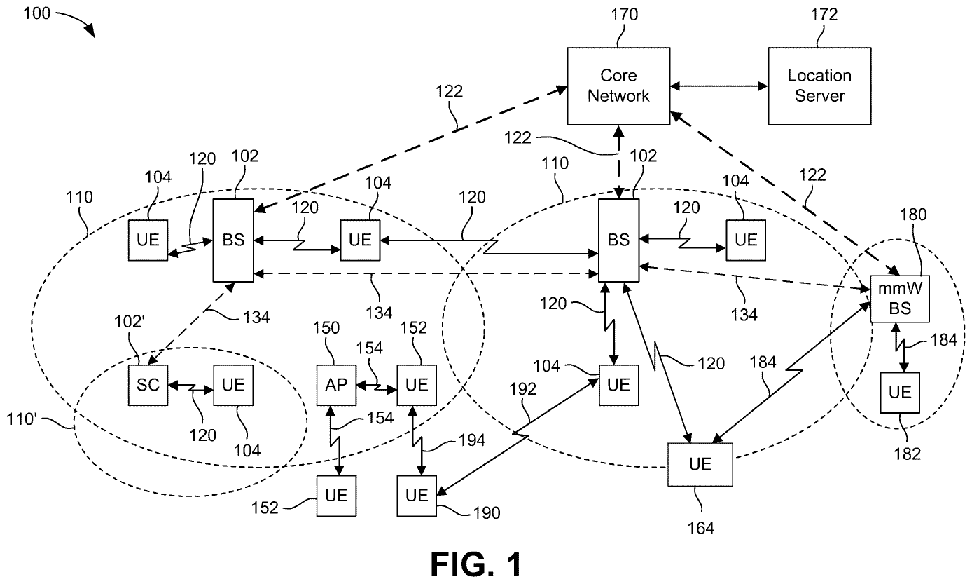

Various aspects of the systems and techniques described herein will be discussed below with respect to the figures. According to various aspects, FIG. 1 illustrates an example of a wireless communications system 100. The wireless communications system 100 (which may also be referred to as a wireless wide area network (WWAN)) may include various base stations 102 and various UEs 104. In some aspects, the base stations 102 may also be referred to as “network entities” or “network nodes.” One or more of the base stations 102 may be implemented in an aggregated or monolithic base station architecture. Additionally, or alternatively, one or more of the base stations 102 may be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 may include macro cell base stations (high power cellular base stations) and/or small cell base stations (low power cellular base stations). In an aspect, the macro cell base station may include eNBs and/or ng-eNBs where the wireless communications system 100 corresponds to a long term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency may be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a WLAN AP 150 in communication with WLAN stations (STAs) 152 via communication links 154 in an unlicensed frequency spectrum (e.g., 5 Gigahertz (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 may include devices (e.g., UEs, etc.) that communicate with one or more UEs 104, base stations 102, APs 150, etc. utilizing the ultra-wideband (UWB) spectrum. The UWB spectrum may range from 3.1 to 10.5 GHz.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW and/or near mmW radio frequency band have high path loss and a relatively short range. The mmW base station 180 and the UE 182 may utilize beamforming (transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges, FR1 (from 450 to 6000 Megahertz (MHz)), FR2 (from 24250 to 52600 MHz), FR3 (above 52600 MHz), and FR4 (between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency and/or component carrier over which some base station is communicating, the term “cell,” “serving cell,” “component carrier,” “carrier frequency,” and the like may be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (x component carriers) for transmission in each direction. The component carriers may or may not be adjacent to each other on the frequency spectrum. Allocation of carriers may be asymmetric with respect to the downlink and uplink (e.g., more or less carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In order to operate on multiple carrier frequencies, a base station 102 and/or a UE 104 may be equipped with multiple receivers and/or transmitters. For example, a UE 104 may have two receivers, “Receiver 1” and “Receiver 2,” where “Receiver 1” is a multi-band receiver that may be tuned to band (i.e., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (an SCell) in order to measure band ‘Y’ (and vice versa). In contrast, whether the UE 104 is being served in band ‘X’ or band ‘Y,’ because of the separate “Receiver 2,” the UE 104 may measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

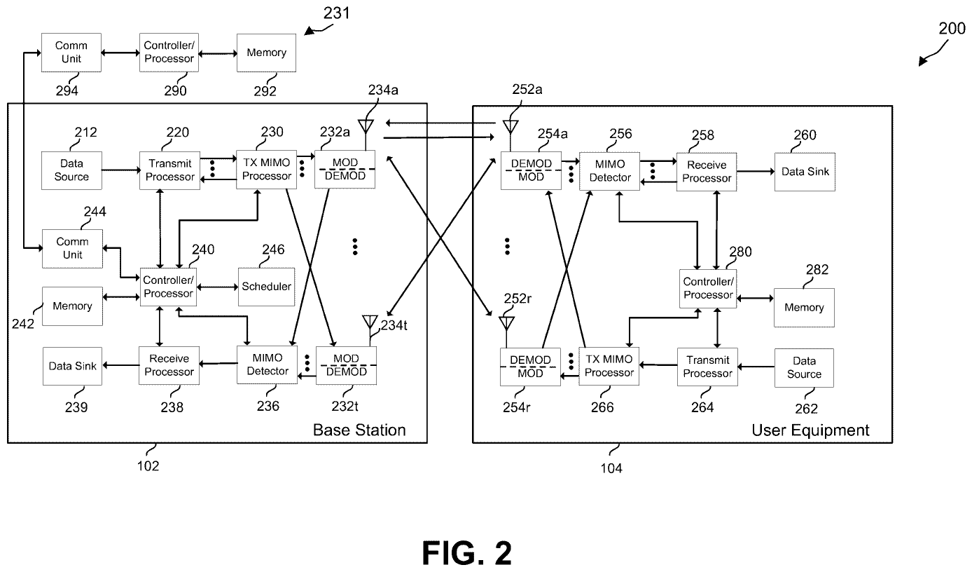

FIG. 2 shows a block diagram of a design of a base station 102 and a UE 104 that enable transmission and processing of signals exchanged between the UE and the base station, in accordance with some aspects of the present disclosure. Design 200 includes components of a base station 102 and a UE 104, which may be one of the base stations 102 and one of the UEs 104 in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, channel state information, channel state feedback, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators may be separate components. Each modulator of the modulators 232a to 232t may process a respective output symbol stream, e.g., for an orthogonal frequency-division multiplexing (OFDM) scheme and/or the like, to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals may be generated with location encoding to convey additional information.

At UE 104, antennas 252a through 252r may receive the downlink signals from base station 102 and/or other base stations and may provide received signals to demodulators (DEMODs) 254a through 254r, respectively. The demodulators 254a through 254r are shown as a combined modulator-demodulator (MOD-DEMOD). In some cases, the modulators and demodulators may be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, channel state information, channel state feedback, and/or the like) from controller/processor 280. Transmit processor 264 may also generate reference symbols for one or more reference signals (e.g., based at least in part on a beta value or a set of beta values associated with the one or more reference signals). The symbols from transmit processor 264 may be precoded by a TX-MIMO processor 266 if application, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 if applicable, and further processed by a receive processor 238 to obtain decoded data and control information sent by UE 104. Receive processor 238 may provide the decoded data to a data sink 239 and the decoded control information to controller (processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit uplink control information (UCI) beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also may be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which may enable flexibility in network design. The various units of the disaggregated base station, or disaggregated RAN architecture, may be configured for wired or wireless communication with at least one other unit.

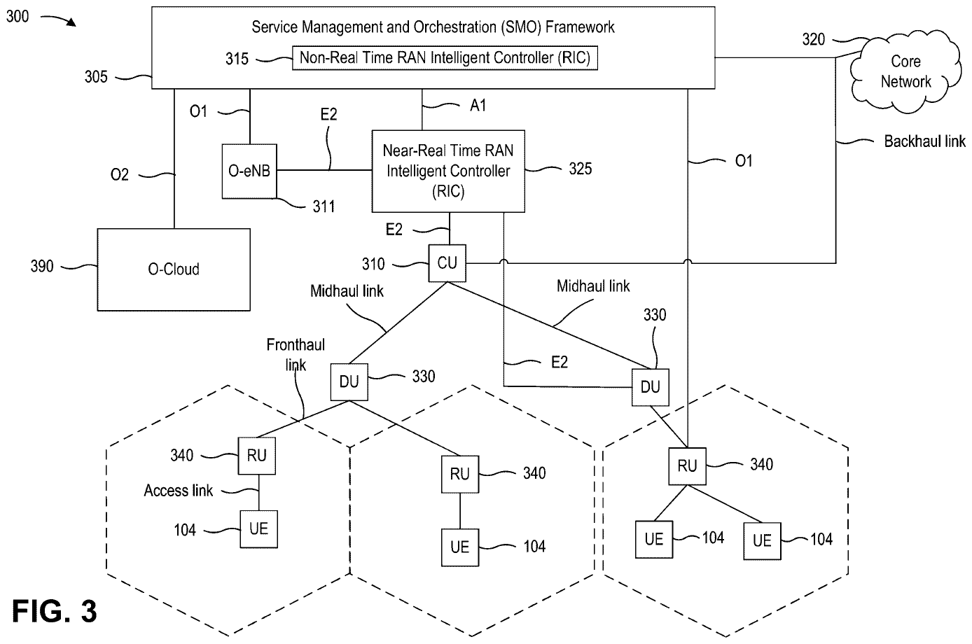

FIG. 3 shows a diagram illustrating an example disaggregated base station 300 architecture. The disaggregated base station 300 architecture may include one or more central units (CUs) 310 that may communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 104 via one or more radio frequency (RF) access links. In some implementations, the UE 104 may be simultaneously served by multiple RUs 340.

Each of the units, e.g., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, may be configured to communicate with one or more of the other units via the transmission medium. For example, the units may include a wired interface configured to receive or transmit signals over a wired transmission medium to one or more of the other units. Additionally, the units may include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions may include radio resource control (RRC), packet data convergence protocol (PDCP), service data adaptation protocol (SDAP), or the like. Each control function may be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 may be logically split into one or more CU-UP units and one or more CU-CP units. The CU-UP unit may communicate bidirectionally with the CU-CP unit via an interface, such as the E1 interface when implemented in an O-RAN configuration. The CU 310 may be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) may be implemented with an interface configured to communicate signals with other layers (and modules) hosted by the DU 330, or with the control functions hosted by the CU 310.

Lower-layer functionality may be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 may be implemented to handle over the air (OTA) communication with one or more UEs 104. In some implementations, real-time and non-real-time aspects of control and user plane communication with the RU(s) 340 may be controlled by the corresponding DU 330. In some scenarios, this configuration may enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements may include, but are not limited to, CUs 310, DUs 330, RUs 340 and Near-RT RICs 325. In some implementations, the SMO Framework 305 may communicate with a hardware aspect of a 4G RAN, such as an open eNB (O-eNB) 311, via an O1 interface. Additionally, in some implementations, the SMO Framework 305 may communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via 01) or via creation of RAN management policies (such as A1 policies).

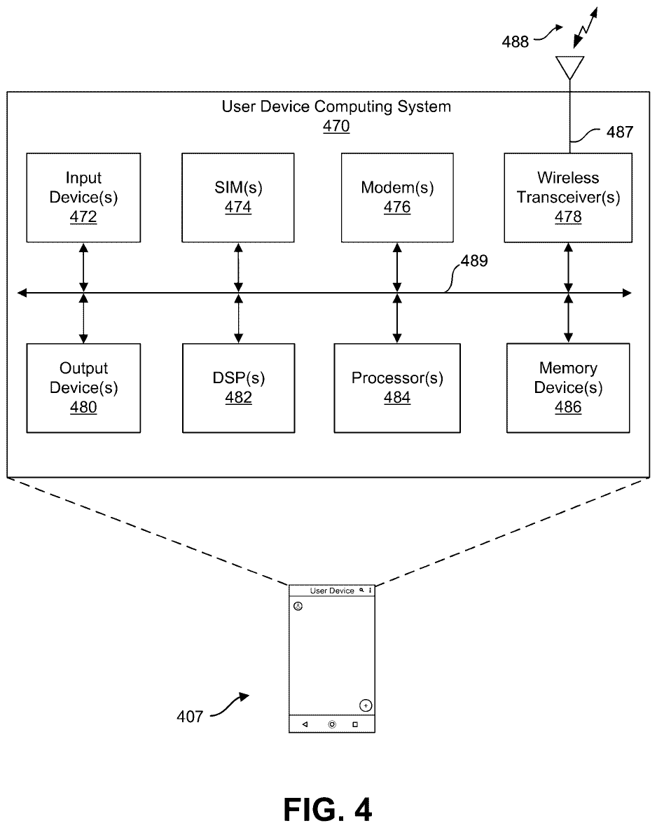

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICs, FPGAs, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

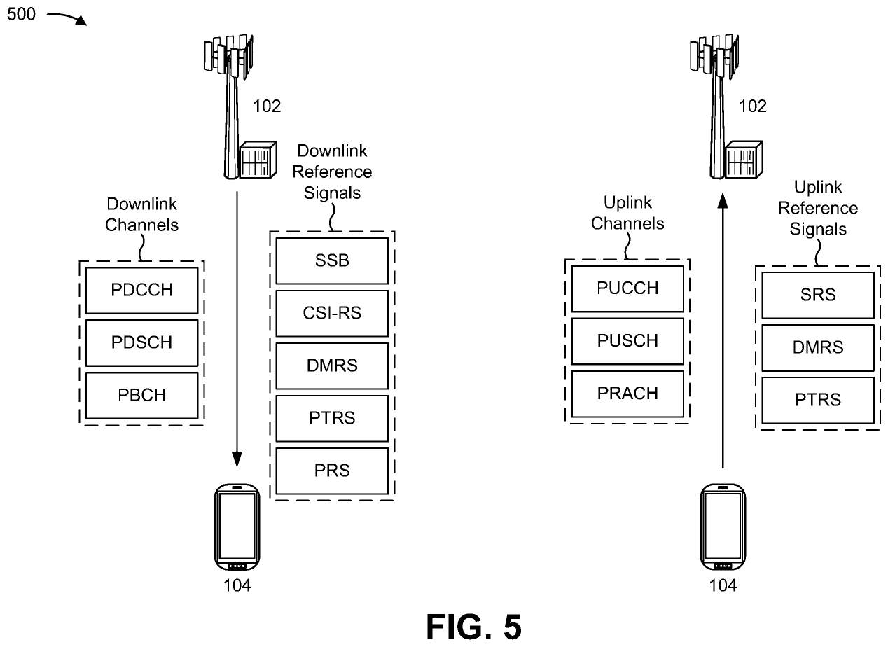

FIG. 5 is a diagram illustrating an example 500 of physical channels and reference signals in a wireless network. In some examples, one or more downlink channels and one or more downlink reference signals may carry information from a base station 102 to a UE 104. One or more uplink channels and one or more uplink reference signals may carry information from UE 104 to base station 102.

In some aspects, a downlink channel may include one or more of a physical downlink control channel (PDCCH) that carries downlink control information (DCI), a physical downlink shared channel (PDSCH) that carries downlink data, and/or a physical broadcast channel (PBCH) that carries system information, among other examples. In some aspects, PDSCH communications may be scheduled by PDCCH communications.

In some examples, an uplink channel may include one or more of a physical uplink control channel (PUCCH) that carries uplink control information (UCI), a physical uplink shared channel (PUSCH) that carries uplink data, and/or a physical random access channel (PRACH) used for initial network access, among other examples. In some aspects, UE 104 may transmit acknowledgement (ACK) or negative acknowledgement (NACK) feedback (e.g., ACK/NACK feedback or ACK/NACK information) in UCI on the PUCCH and/or the PUSCH.

In some cases, a downlink reference signal may include one or more of a synchronization signal block (SSB), a channel state information (CSI) reference signal (CSI-RS), a demodulation reference signal (DMRS), a positioning reference signal (PRS), and/or a phase tracking reference signal (PTRS), among other examples. In some examples, an uplink reference signal may include one or more of a sounding reference signal (SRS), a DMRS, and/or a PTRS, among other examples.

An SSB may carry or include information used for initial network acquisition and synchronization. For example, an SSB can carry or include one or more of a primary synchronization signal (PSS), a secondary synchronization signal (SSS), a PBCH, and/or a PBCH DMRS. An SSB may also be referred to as a synchronization signal/PBCH (SS/PBCH) block. In some aspects, base station 102 may transmit multiple SSBs on multiple corresponding beams, and the SSBs may be used for beam selection.

A CSI-RS may carry information used for downlink channel estimation (e.g., downlink CSI acquisition), which may be used for scheduling, link adaptation, or beam management, among other examples. For example, base station 102 can configure a set of CSI-RSs for UE 104, and UE 104 can measure the configured set of CSI-RSs. Based on the CSI-RS measurements, UE 104 can perform channel estimation and report channel estimation parameters to base station 102 (e.g., in a CSI report). For example, the channel estimation parameters can include one or more of a channel quality indicator (CQI), a precoding matrix indicator (PMI), a CSI-RS resource indicator (CRI), a layer indicator (LI), a rank indicator (RI), and/or a reference signal received power (RSRP), among other examples.

In some examples, base station 102 can use the CSI report to select transmission parameters for downlink communications to UE 104. For example, base station 102 can use the CSI report to select transmission parameters that include one or more of a quantity of transmission layers (e.g., a rank), a precoding matrix (e.g., a precoder), a modulation and coding scheme (MCS), and/or a refined downlink beam (e.g., using a beam refinement procedure or a beam management procedure), among other examples.

A DMRS may carry information used to estimate a radio channel for demodulation of an associated physical channel (e.g., PDCCH, PDSCH, PBCH, PUCCH, or PUSCH). The design and mapping of a DMRS may be specific to a physical channel for which the DMRS is used for estimation. DMRSs are UE-specific, can be beamformed, can be confined in a scheduled resource (e.g., rather than transmitted on a wideband), and can be transmitted only when necessary. As shown, DMRSs are used for both downlink communications and uplink communications.

A PTRS can carry information used to compensate for oscillator phase noise. In some cases, oscillator phase noise may increase as an oscillator carrier frequency increases. In some examples, a PTRS can be utilized at high carrier frequencies (e.g., such as millimeter wave frequencies) to mitigate oscillator phase noise. The PTRS may be used to track the phase of the local oscillator and to enable suppression of phase noise and common phase error (CPE). As illustrated in FIG. 5, in some examples one or more PTRSs can be used for both downlink communications (e.g., on the PDSCH) and uplink communications (e.g., on the PUSCH).

A PRS may carry information associated with timing or ranging measurements of UE 104. For example, UE 104 may utilize one or more signals (e.g., PRSs) transmitted by base station 102 to improve an observed time difference of arrival (OTDOA) positioning performance. In some examples, a PRS may be a pseudo-random Quadrature Phase Shift Keying (QPSK) sequence mapped in diagonal patterns with shifts in frequency and time to avoid collision with cell-specific reference signals and control channels (e.g., a PDCCH). A PRS can be designed to improve detectability by UE 104, which may need to detect downlink signals from multiple neighboring base stations in order to perform OTDOA-based positioning. Accordingly, UE 104 may receive a PRS from multiple cells (e.g., a reference cell and one or more neighbor cells), and may report a reference signal time difference (RSTD) based on OTDOA measurements associated with the PRSs received from the multiple cells. In some aspects, base station 102 can calculate a position of UE 104 based on the RSTD measurements reported by UE 104.

In some examples, an SRS can carry information used for uplink channel estimation, which may be used for scheduling, link adaptation, precoder selection, and/or beam management, among other examples. Base station 102 can configure one or more SRS resource sets for UE 104, and UE 104 can transmit SRSs on the configured SRS resource sets. An SRS resource set may have a configured usage, such as uplink CSI acquisition, downlink CSI acquisition for reciprocity-based operations, uplink beam management, among other examples. Base station 102 may measure the SRSs, may perform channel estimation based on the measurements, and/or may use the SRS measurements to configure communications with UE 104.

As mentioned previously, the systems and techniques described herein can be used to generate a beam measurement information report with a reduced UL signaling overhead. For instance, the systems and techniques can be used to generate beam measurement information corresponding to one or more beam prediction use cases at a network entity (e.g., gNB, base station, etc.) that receives the beam measurement information report from the UE. For instance, the beam measurement information (e.g., included in and/or indicated by the beam measurement information report) can be associated with data collection for training one or more beam prediction AI or ML models at a network entity (e.g., base station, gNB, etc.) and/or can be associated with data collection for performing inference using one or more beam prediction AI or ML models at a network entity. AI and ML models utilize large quantities of data during training, and in some cases performance during inference may be improved based on providing a larger quantity of input data. Based on reducing the UL signaling overhead associated with L1 beam measurement information reports generated by a UE, the systems and techniques can be used to increase the amount of beam measurement information reports that can be received by a network entity using the same number of bits. Additionally, reducing the UL signaling overhead associated with L1 beam measurement information reports generated by a UE can allow a network entity to receive beam measurement information at an increased rate per unit time.

In some aspects, the overhead reduction can be implemented for reporting of beam measurement information associated with at least one reference signal that is transmitted by a network entity and/or received by a UE. For instance, the systems and techniques can provide reduced UL signaling overhead for a beam measurement information report corresponding to one or more channel measurement resources (CMRs), such as synchronization signal blocks (SSBs), Channel State Information (CSI) Reference Signals (CSI-RSs), etc.

In some aspects, the overhead reduction can be implemented for reporting of beam measurement information associated with a virtual reference signal (e.g., or other virtual signal) that is not transmitted by the network entity and is not received by the UE. For example, the network entity can configure the UE with information indicative of one or more channel prediction resources (CPRs) (e.g., also referred to as “virtual channel resources” and/or “virtual resources”), such as SSBs, CSI-RSs, and/or various other virtual resources not actually transmitted by the network entity. The systems and techniques can provide reduced UL signaling overhead for a beam measurement information report corresponding to the one or more CPRs.

In one illustrative example, the reduced overhead beam measurement information report can be indicative of beam measurement information for a plurality of channel resources (e.g., CMRs or CPRs) and can one or more reference values (e.g., also referred to as “common reference values”). The one or more reference values can be used for differential quantization of mean measurement information determined by the UE for a corresponding subset of the plurality of channel resources (e.g., each particular reference value corresponds to a different subset of the plurality of channel resources, which are each reported relative to the particular reference value).

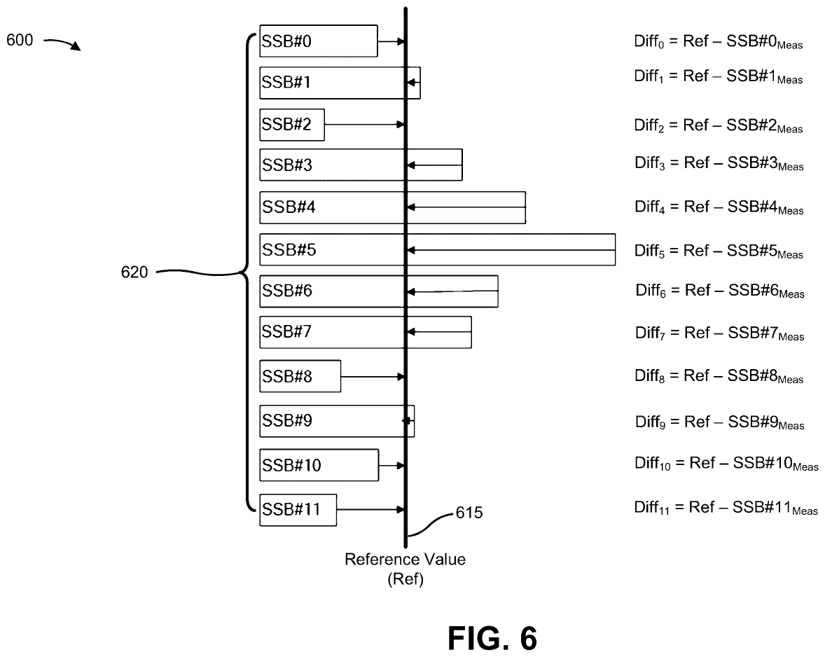

For example, FIG. 6 is a diagram illustrating an example of beam-independent reference-based feedback 600. In one illustrative example, the beam-independent reference-based feedback 600 can be beam-independent reference-based L1 RSRP/SINR feedback. In some aspects, a UE can be configured to measure, determine, and/or provide feedback information for a plurality of channel resources 620. For instance, the UE can be configured to provide (e.g., to a network entity such as a base station or gNB) feedback information indicative of L1-RSRPs or L1-SINRs for the plurality of channel resources 620.

In one illustrative example, the plurality of channel resources 620 includes a plurality of SSBs (e.g., SSB #0, SSB #1, . . . , SSB #11). In some cases, the plurality of channel resources 620 can include a plurality of CSI-RSs, and/or various other downlink reference signals (RSs). The plurality of channel resources 620 can be channel measurement resources (CMRs) or can be channel prediction resources (CPRs). In examples where the plurality of channel resources 620 are CPRs, the plurality of channel resources 620 may include SSBs, CSI-RSs, or virtual resources configured for the UE by a network entity but not actually transmitted by the network entity and not actually received by the UE.

To generate a beam measurement information report, the UE can determine beam measurement information for each channel resource of the plurality of channel resources 620. The beam measurement information can be an RSRP value, an SINR value, etc. For instance, if the plurality of channel resources 620 are CMRs, a corresponding DL reference signal is associated with the plurality of channel resources 620 and can be measured by the UE (e.g., if the plurality of channel resources 620 are CMRs, the RSRP or SINR values can be measured at the UE). If the plurality of channel resources 620 are CPRs, a corresponding DL reference signal may be transmitted or may not be transmitted. In examples where the plurality of channel resources 620 are CPRs and a corresponding DL reference signal is not transmitted (e.g., is not received by the UE), the RSRP or SINR values can be predicted values determined (e.g., generated) by the UE.

In the example of FIG. 6, each channel resource of the plurality of channel resources 620 (e.g., each SSB of SSB #0-SSB #11) is associated with a corresponding measurement information, indicated based on the horizontal extent of the bar used to depict each channel resource measurement. For instance, the same type of measurement or feedback information can be determined by the UE for each channel resource of the plurality of channel resources 620 (e.g., RSRP in dB, SINR, etc.). The measurement information determined for the plurality of channel resources 620 can include different values for some, or all, of the individual channel resources. For instance, in the example of FIG. 6, the measurement information (e.g., RSRP/SINR value) for SSB #0 is less than the measurement information (e.g., RSRP/SINR value) for SSB #1, and the measurement information for SSB #2 is less than the corresponding measurement information for both SSB #0 and SSB #1, etc.

In one illustrative example, a reference value 615 (e.g., “Ref”) can be determined based on the measurement information of the plurality of channel resources 620. For instance, the reference value 615 can be a reference L1-RSRP/SINR value, in examples where the measurement information for the plurality of channel resources 620 is also determined as respective L1-RSRP/SINR values (e.g., when the measurement information for each channel resource is an RSRP value, the reference value 615 can be a reference RSRP value; when the measurement information for each channel resource is an SINR value, the reference value 615 can be a reference SINR value; etc.). The reference value 615 can be a common reference, corresponding to or associated with each channel resource of the plurality of channel resources 620. In some aspects, the reference value 615 can be a beam-independent reference, reported independently from the measurement information for the plurality of channel resources 620. As used herein, the “reference value” may also be referred to as a “common reference,” “common reference value,” and/or “beam-independent common reference.”

In some aspects, the reference value 615 can be determined by the UE, based on analyzing the respective measurement information measured or predicted for the plurality of channel resources 620. For instance, L1-RSRP/SINR values across beams (e.g., across channel resources) may be more likely to be centered around a particular value, and the UE can determine reference value 615 based on identifying a central value (and/or central value range) within the plurality of L1-RSRP/SINR values measured or predicted for the plurality of channel resources 620. For example, multipath propagation can cause a transmitted signal to reach the UE over different paths across the plurality of beams or channel resources. At least a portion of the beams or channel resources can be associated with similar channel conditions, resulting in the plurality of L1-RSRP/SINR measurements being approximately centered around a particular value. Based on the multipath propagation associated with some (or all) of the plurality of channel resources 620, the UE may measure or predict L1-RSRP/SINR values that do not follow a random distribution but include one or more central values about which the L1-RSRP/SINR values are clustered.

In one illustrative example, the UE can determine reference value 615 after measuring a respective L1-RSRP/SINR value for each channel resource of the plurality of channel resources 620 (e.g., in examples where channel resources 620 are CMRs) or after predicting a respective L1-RSRP/SINR value for each of the channel resources 620 (e.g., in examples where channel resources 620 are CPRs). In some aspects, reference value 615 can be determined as an optimization between reporting overhead and quantization granularity. For instance, reporting overhead can vary based on the numerical range of the respective differential values between each channel resource LI-RSRP/SINR value and the selected reference value 615. Quantization granularity can vary based on the distribution of different L1-RSRP/SINR values around the selected reference value 615, as will be described in greater depth below.

In some aspects, the plurality of channel resources 620 can include a total of R₀ different channel resources. For instance, in the example of FIG. 6, the plurality of channel resources 620 includes 12 SSBs, and R₀=12. In some examples, the R₀ channel resources (e.g., SSBs, CSI-RSs, virtual resources, etc.) can be indicated or configured by the network entity for inclusion in a Channel State Information (CSI) report and/or other beam measurement information report that is to be generated by the UE. In some aspects, the plurality of channel resources 620 comprises a plurality of CMRs or comprises a plurality of CPRs (e.g., the plurality of channel resources 620 does not include a combination of CMRs and CPRs).

In some cases, the UE can generate the CSI report (or other beam measurement information report) to include all of the CMRs associated with or available to the UE, or to include all of the CPRs associated with or available to the UE. In another example, the UE can generate the CSI report (or other beam measurement information report) to include an identified or configured subset of the CMRs associated with or available to the UE, or to include an identified or configured subset of the CPRs associated with or available to the UE. For instance, a network entity (e.g., base station, gNB, etc.) can configured or indicate the selection of the subset of CMRs or CPRs to the UE in a configuration information. In one illustrative example, the network entity can use a MAC-CE activating the SP CSI report to indicate which CMRs or CPRs should be addressed in the beam measurement information report generated and transmitted by the UE in response to the MAC-CE (e.g., a CSI report). In another example, the network entity can use an alternative or dedicated MAC-CE (e.g., different from the MAC-CE activation the SP CSI report) to indicate which CMRs or CPRs should be addressed by the UE. In some aspects, the network entity can transmit a DCI indicative of the subset of CMRs or CPRs to be addressed by the UE in the beam measurement information CSI report.

In some aspects, the plurality of channel resources 620 can include a total of R₀ different channel resources. For instance, in the example of FIG. 6, the plurality of channel resources 620 includes 12 SSBs, and R₀=12. In some examples, the R₀ channel resources (e.g., SSBs, CSI-RSs, virtual resources, etc.) can be indicated or configured by the network entity for inclusion in a Channel State Information (CSI) report and/or other beam measurement information report that is to be generated by the UE. In some aspects, the plurality of channel resources 620 comprises a plurality of CMRs or comprises a plurality of CPRs (e.g., the plurality of channel resources 620 does not include a combination of CMRs and CPRs).

In some cases, the UE can generate the CSI report (or other beam measurement information report) to include all of the CMRs associated with or available to the UE, or to include all of the CPRs associated with or available to the UE. In another example, the UE can generate the CSI report (or other beam measurement information report) to include an identified or configured subset of the CMRs associated with or available to the UE, or to include an identified or configured subset of the CPRs associated with or available to the UE. For instance, a network entity (e.g., base station, gNB, etc.) can configured or indicate the selection of the subset of CMRs or CPRs to the UE in a configuration information. In one illustrative example, the network entity can use a MAC-CE activating the SP CSI report to indicate which CMRs or CPRs should be addressed in the beam measurement information report generated and transmitted by the UE in response to the MAC-CE (e.g., a CSI report). In another example, the network entity can use an alternative or dedicated MAC-CE (e.g., different from the MAC-CE activation the SP CSI report) to indicate which CMRs or CPRs should be addressed by the UE. In some aspects, the network entity can transmit a DCI indicative of the subset of CMRs or CPRs to be addressed by the UE in the beam measurement information CSI report.

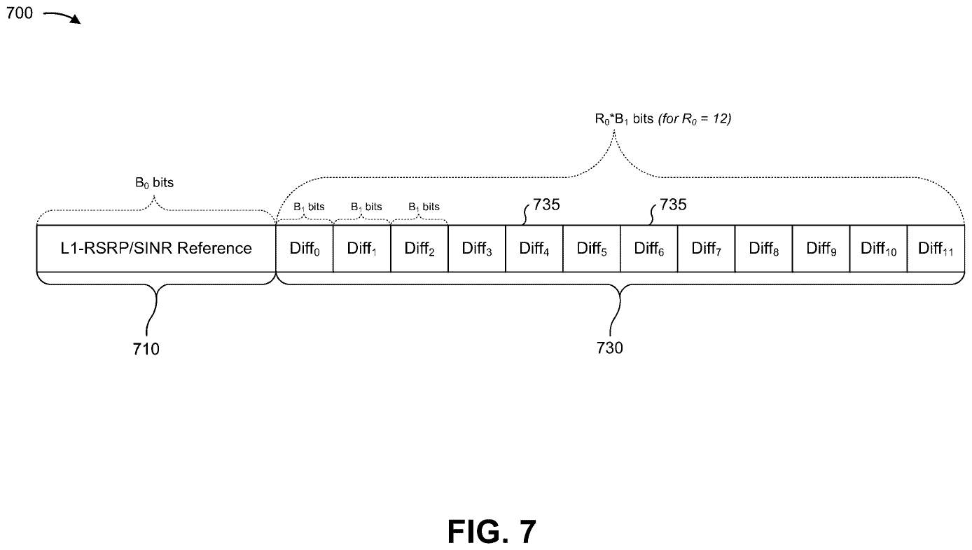

In one illustrative example, the UE can generate the beam measurement information CSI report to include the common L1-RSRP/SINR reference value 615 (e.g., as determined or selected by the UE, based on the individual L1-RSRP/SINR measurements for each channel resource 620). The common L1-RSRP/SINR reference value 615 can be included in the report using B₀ bits (e.g., seven bits). The UE can further report the respective L1-RSRP/SINR value for each of the R₀ CMRs or CPRs (e.g., each one of the plurality of channel resources 620), using B₁ bits for each respective L1-RSRP/SINR value. For instance, on B₁ bits, each respective L1-RSRP/SINR value can be differentially referred to the common L1-RSRP/SINR value 615 (e.g., for a total of R₀*B₁ bits for the full differential reporting of the plurality of respective L1-RSRP/SINR values for the plurality of channel resources 620. In some aspects, the UE can generate the beam measurement information CSI report to be the same as or similar to the example beam measurement information report 700 of FIG. 7, as will be described below. In some cases, the UE generates the beam measurement information report without including or indicating a CMR-ID or CPR-ID for any of the plurality of channel resources 620. For instance, generating the beam measurement information report without CMR-ID or CPR-ID information can provide a further reduction in UL signaling overhead for the report, as including the CMR-ID or CPR-ID information may cause the ID information to become dominant in the report (e.g., in terms of total bit share of the report).

In one illustrative example, the differential reporting of the respective L1-RSRP/SINR values can be based on a differential quantization of +dB and −dB values determined between the common L1-RSRP/SINR reference and each respective L1-RSRP/SINR for the plurality of channel resources 620. For instance, SSB #0 can be associated with a corresponding differential value Diff₀=Ref−SSB #OMeas, where “Ref” represents the common L1-RSRP/SINR value 615 and SSB #OMeas represents the measured (or predicted, if SSB #0 is a CPR) L1-RSRP/SINR determined for SSB #0. SSB #1 can be associated with a corresponding differential value Diff₁=Ref−SSB #1_{Mcas}, SSB #2 can be associated with a corresponding differential value Diff₂=Ref−SSB #2_{Meas}, . . . , etc.

As noted previously, FIG. 7 is a diagram illustrating an example of a measurement report 700 indicative of a beam-independent reference value and a plurality of differential values relative to the beam-independent reference value, in accordance with some examples. In one illustrative example, the beam-independent reference value 710 can be included in a first portion of the measurement report 700, and may be an L1-RSRP/SINR reference value. The beam-independent reference value 710 may be the same as or similar to the beam-independent common reference value 615 of FIG. 6, and is reported on B₀ bits.

The measurement report 700 can be a CSI report. In addition to including the beam-independent reference value 710 reported on B₀ bits, the measurement report 700 can further include a respective differential reporting 735 indicative of a respective beam measurement information for each channel resource of a plurality of channel resources. For instance, each respective differential reporting 735 can correspond to a different channel resource, such as the channel resources 620 of FIG. 6 (e.g., SSB #0-SSB #11 of FIG. 6). The respective beam information indicated by each differential reporting 735 can be an L1-RSRP/SINR value measured or predicted by the UE for a particular channel resource, differentially reported relative to the beam-independent reference value 710. Each respective differential reporting 735 can be reported on B₁ bits, where B₁ is less than B₀. For instance, in some cases B₀=7 bits and B₁=2 bits. The plurality of differential reporting 735 can be included in a plurality of differential values 730, which may also be referred to as a “payload” of the measurement report 700. The payload 730 can be reported on R₀*B₀ bits, where R₀ represents the quantity of individual channel resources of a plurality of channel resources associated with the measurement report 700.

In some aspects, the values of B₀ and B₁ can be pre-determined. For instance, the values of B₀ and B₁ can be pre-defined by a standards document or specification, and can be pre-configured for the UE and for the network entity. In some cases, the values of B₀ and B₁ can be pre-defined in combination with an absolute or differential L1-RSRP/SINR definition of respective bit-points to be used for the differential quantization of the differential reporting payload 730.

In another example, a plurality of different combinations of pre-determined definitions (e.g., pre-determined or pre-configured values) for B₀ and B₁ can be provided together with the absolute or differential L1-RSRP/SINR definition of the respective bit-points for the differential quantization. Each unique combination of B₀ and B₁ values with an L1-RSRP/SINR definition of bit-points can be associated with a unique option-ID. In some aspects, the network entity (e.g., gNB, base station, etc.) can configure and/or indicate to the UE a particular option-ID that is to be used to generate the measurement report 700. For instance, the network entity can include the selected or configured option-ID in the RRC configuration of the corresponding CSI report 700 setting. In another example, the MAC-CE activating the SP CSI report 700 (e.g., transmitted by the network entity and received by the UE) can include or indicate the selected or configured option-ID. In another example, the CSI-AssociatedReportConfigInfo with respect to the AP CSI report can include or indicate the selected or configured option-ID.

In another illustrative example, the UE can indicate to the network entity a particular option-ID used to generate the measurement report 700, such that the network entity receives the measurement report 700 and uses the indicated option-ID to determine the choice of B₀ and B₁ together with the absolute or differential L1-RSRP/SINR definition of respective bit-points that was used by the UE to generate the measurement report 700. The plurality of option-IDs and the corresponding mapping to different choices of B₀ and B₁ together with bit-point definitions can be pre-configured in the UE and network entity (e.g., based on a standards definition) and/or can be configured as described above based on configuration information transmitted from the network entity to the UE.

In some examples, the UE can generate and transmit the measurement report 700 using one-part CSI reporting or using two-part CSI reporting. For instance, in two-part CSI report, the part-1 payload is the beam-independent L1-RSRP/SINR reference value 710, and has a fixed size (e.g., B₀ bits). The part-2 payload is the differential reporting payload 730, which can have a variable size (e.g., variable number of bits). In some aspects, the part-1 payload further includes or is indicative of the choice of option-ID utilized by the UE to generate the measurement report 700, which includes the choice of the absolute or differential L!-RSRP/SINR definition of the respective bit-points used for differential quantization of the L1-RSRP/SINR values indicated in the differential reporting payload 730. The size (e.g., number of bits) of the part-2 payload can vary based on the choice of bit-point definition utilized by the UE and reported in the part-1 payload 710 of the two-part CSI report. For example, different bit-point definitions for the differential quantization (relative to the beam-independent L1-RSRP/SINR common reference 710) of the respective L1-RSRP/SINR values measured or predicted for the plurality of CMRs or CPRs can use different step-sizes and/or different threshold dB values for the front and end bit-points, which can result in different bit quantities needed to report the part-2 differential payload 730 of the two-part CSI measurement report.

In another example, if the different candidate options (e.g., associated with the different option-IDs) all comprise identical values for B₀ and B₁, while the differences between each option-ID comprise the L1-RSRP/SINR definition of respective bit-points (e.g., different step-sizes and threshold dB values for the front and end bit-points), then the measurement report 700 can be generated and transmitted as a one-part CSI report. In the one-part CSI report, the UE can report the option-ID together with the L1-RSRP/SINRs using a fixed payload size.

In one illustrative example, the differential reporting payload 730 can be generated using a differential quantization of respective L1-RSRP/SINR values determined (e.g., measured or predicted) for each channel resource (e.g., CMRs or CPRs, respectively). In some aspects, the quantization step-size of the differential dB value can be linear. In some cases, the quantization step-size of the differential dB value X can be non-linear. For example, a linear quantization step-size can be implemented where each component is quantized using one bit-point (e.g., X<−18 dB, −18 dB≤X<−12 dB, −12 db≤X<−6 dB, −6 db≤X<0 dB, OdB≤X<6 dB, 6 dB≤X<12 dB, 12 dB≤X<18 db, 18 dB≤X). In another example, a non-linear quantization step-size can be implemented where each component is quantized using one bit-point (e.g., X<−20 dB, −20 dB≤X<−9 dB, −9 db ≤X<−3 dB, −3 db≤X<0 dB, 0 dB≤X<3 dB, 3 dB≤X<9 dB, 9 dB≤X<20 db, 20 dB≤X). In some aspects, non-linear quantization may be associated with a smaller number of bits needed to perform the differential reporting of the differential L1-RSRP/SINR payload 730.

In some aspects, an L1-RSRP/SINR measurement report can be generated based on dividing the plurality of channel resources into one or more segments, where each segment has a corresponding beam-independent L1-RSRP/SINR common reference value and where the measured L1-RSRP/SINR values for the channel resources of a particular segmented are differentially quantized relative to the corresponding common reference for the particular segment. Each segment includes a disjoint subset of the plurality of channel resources associated with the measurement report. For instance, 20 channel resources (e.g., CMRs or CPRs) can be divided into four CMR/CPR segments each including five CMRs or CPRs. As used herein, the terms “segment” and “group” may be used interchangeably (e.g., a channel resource segment can be referred to as a channel resource group; a channel resource segment can also be referred to as a CMR/CPR segment, which is interchangeably referred to as a CMR/CPR group).

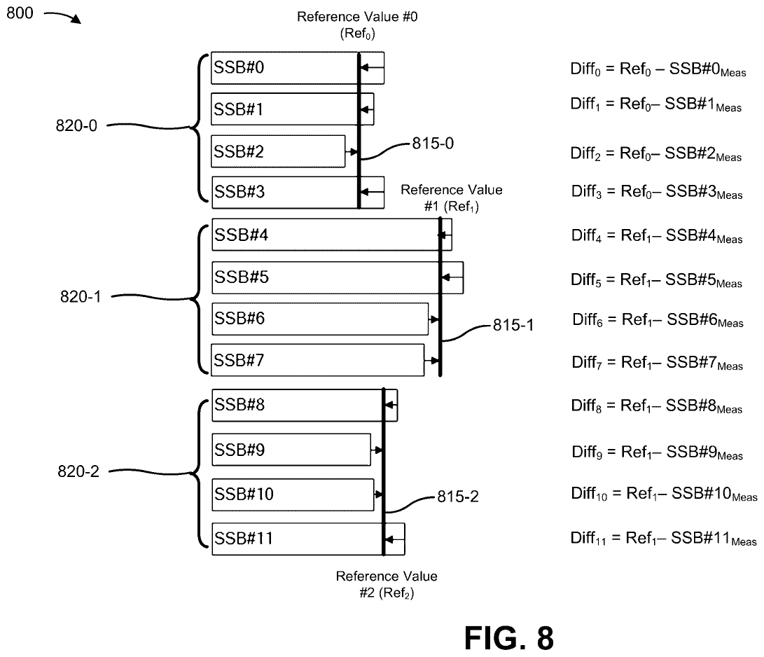

FIG. 8 is a diagram illustrating an example of group-based beam measurement information 800, which can be performed for a plurality of channel resource groups (e.g., CMR/CPR segments) each associated with a respective one of a plurality of beam-independent reference values, in accordance with some examples. In some aspects, a plurality of channel resources can include the SSBs SSB #0-SSB #11, which can be the same as or similar to the plurality of SSBs 620 of FIG. 6 (e.g., SSB #0-SSB #11 of FIG. 6). In one illustrative example, the plurality of channel resources (e.g., plurality of SSBs) can be divided into N different channel resource groups. For instance, for N=3, the plurality of channel resources can be divided into a first channel resource group 820-0 including SSB #0-SSB #3, a second channel resource group 820-1 including SSB #4-SSB #7, and a third channel resource group 820-2 including SSB #8-SSB #11.

In some aspects, the UE can be configured to identify N segments (e.g., N CMR/CPR groups) associated with the R₀ CMRs/CPRs (e.g., the plurality of channel resources). Each of the N segments comprises Rₙ,

$$1 \leq n \leq N CMRs / CPRs ( {\sum }_{n = 1}^{N} {R}_{n} = {R}_{0} ) .$$

For the n^{th} CMR/CPR segment of the N total segments, the UE can generate the measurement report by reporting a common L1-RSRP/SINR reference value determined for and corresponding to the Rₙ CMRs/CPRs included in the n^{th} segment. Each common of the N L1-RSRP/SINR reference values for the N segments can be determined the same as described above with respect to FIGS. 6 and 7, and may be reported on B₀ bits. The UE can further report an L1-RSRP/SINR measured or predicted value for each of the Rₙ CMRs/CPRs of the n^{th} segment (e.g., n^{th} segment), by using B₁ bits to report the differential quantization indicative of each L1-RSRP/SINR value relative to the corresponding common L1-RSRP/SINR reference value for the n^{th} segment. The differential quantization on B₁ bits for each measured or predicted L1-RSRP/SINR value can be the same as described above with respect to FIGS. 6 and 7, and can be based on +dB and −dB values. In some aspects, the measurement report based on CMR/SPR segments can be generated without capturing or indicating any CMR-ID or CPR-ID information, again as described previously above.

For example, Segment #0 820-0 can be reported based on B₀ bits indicative of a common L1-RSRP/SINR reference value 815-0 (referred to as Ref₀) determined for the SSBs #0-3 included in Segment #0 820-0. Reference value 815-0 can be determined the same as or similar to the reference value 615 of FIG. 6. Segment #1 820-1 can be reported based on B₀ bits indicative of a common L1-RSRP/SINR reference value 815-1 (referred to as Ref₁) determined for the SSBs #4-7 included in Segment #1 820-1. Reference value 815-1 can be determined the same as or similar to the reference value 615 of FIG. 6. Segment #2 820-2 can be reported based on B₀ bits indicative of a common L1-RSRP/SINR reference value 815-2 (referred to as Ref₂) determined for the SSBs #8-11 included in Segment #2 820-2. Reference value 815-2 can be determined the same as or similar to the reference value 615 of FIG. 6.

In some aspects, the value of N used to determine the plurality of segments for a plurality of channel resources (e.g., CMRs or CPRs) can be pre-determined based on a corresponding definition in a standards document or standard implementation across the UE and network entity. For instance, the value of N can pre-defined based on the value of R₀ (e.g., the total quantity of CMRs/CPRs included in the measurement report). In one example, the UE can generate the measurement report using N=1 when 1≤R₀≤8, N=2 when 8<R₀≤16, N=3 when 16<R₀≤24, N=4 when 16<R₀≤32, etc.

In some aspects, for the {1^{st}, 2^{nd}, . . . , (N−1)^{th}} segments, each segment can include [R₀/N] CMRs/CPRs. The final segment (e.g., the N^{th} segment) may include a greater or lesser number of CMRs/CPRs in examples where R₀ is not evenly divisible by N. In one illustrative example, the final segment (e.g., the N^{th} segment) can include a number of CMRs/CPRs that is greater than [R₀/N]. In another illustrative example, the final segment (e.g., the N^{th} segment) can include a number of CMRs/CPRs that is less than [R₀/N]. In some aspects, the final segment (e.g., the N^{th} segment) can include [R₀/N] segments (e.g., when R₀ is evenly divisible by N). In some aspects, the CMRs/CPRs can be addressed in the N segments sequentially, for example according to increasing order of the respective CMR-IDs or CPR-IDs.

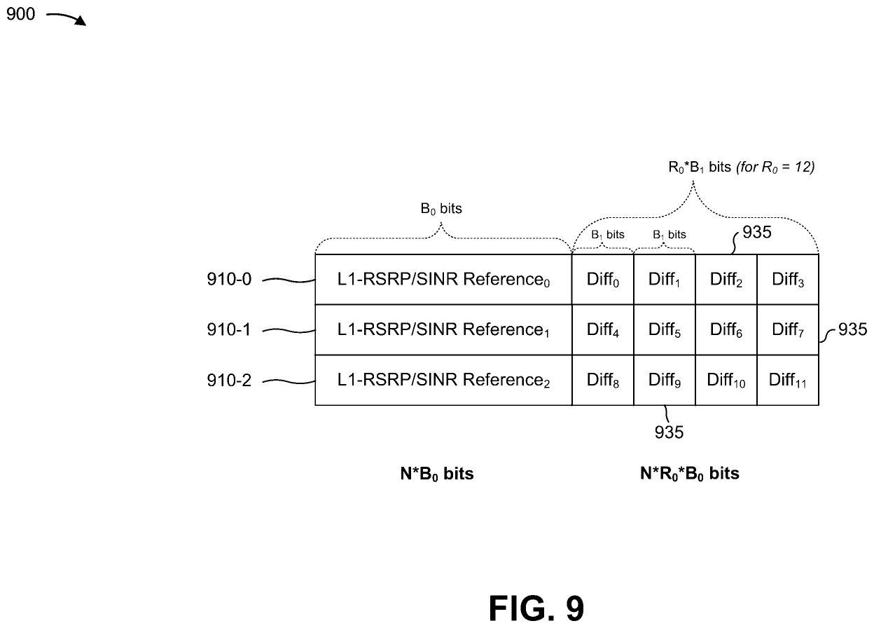

In another illustrative example, the value of N and the selection of whether the N^{th} segment should include a greater or lesser number of CMRs/CPRs than the 1^{st} through (N−1)^{th} segments can be indicated by the network entity (e.g., gNB, base station, etc.) For instance, the network entity can transmit, and the UE can receive, configuration information indicative of the value of N and the handling of the N^{th} segment generation. In some examples, the network entity can transmit the configuration information as an RRC configured by the CSI report setting associated with the CSI report (e.g., CSI beam measurement information report, such as the example report 700 of FIG. 7 or the example report 900 of FIG. 9). In another example, the network entity can use the MAC-CE activating the SP CIS report (e.g., the example report 700 of FIG. 7 or the example report 900 of FIG. 9) to indicate a selection from a standard pre-defined or CSI report setting plurality of pre-configured option-IDs. In another example, the network entity can use CSI-AssociatedReportConfigInfo associated with the AP CSI report to indicate a selection from the standard pre-defined or CSI report setting plurality of pre-configured option-IDs. In some cases, the selection of the value of N can be determined and indicated by the network entity, and the selection of whether the N^{th} segment should include a greater or lesser number of CMRs/CPRs than the 1^{st} through (N−1)^{th} segments can be pre-determined by a standards configuration or specification.

In some aspects, the value of N can be determined by the UE, and can be included in and/or indicated by the multi-segment measurement report generated and transmitted by the UE. For instance, the multi-segment measurement report generated and transmitted by the UE can be the same as or similar to example measurement report 900 of FIG. 9. In some cases, the UE can additionally determine and indicate (e.g., in the multi-segment measurement report 900, or other multi-segment measurement report) the choice of whether to include a greater or lesser number of CMRs/CPRs in the N^{th} segment than the remaining N−1 segments. For example, the multi-segment measurement report 900 generated and transmitted by the UE can be a CSI report. The CSI report can indicate a selection of an option-ID from among a plurality of option-IDs, where the plurality of option-IDs correspond to different combinations of values of N and whether the N^{th} segment includes a greater or lesser number of CMRs/CPRs. The plurality of option-IDs can be standard pre-defined or CSI report setting preconfigured, as described previously above.

In some cases, the payload size of the multi-segment measurement report 900 can vary, and a two-part CSI report can be used. For instance, the payload size of the multi-segment measurement report 900 can vary based on the choice of N, as each CMR/CPR segment (e.g., CMR/CPR group) is associated with a corresponding beam-independent L1-RSRP/SINR common reference value that is reported using a full B₀ bits. In one illustrative example, the selected option-ID utilized by the UE in generating the multi-segment measurement report 900 and in determining the plurality of segments N can be included in and/or indicated by part-1 of the two-part CSI report, and the N beam-independent common reference L1-RSRP/SINR values can be reported in part-2 of the two-part CSI report in combination with the differential L1-RSRP/SINR values determined for each of the N segments. For instance, the example measurement report 900 of FIG. 9 can be a multi-segment L1-RSRP/SINR report using a two-part CSI. The first segment 820-0 and Ref₀ 815-0 of FIG. 8 can correspond to the first L1-RSRP/SINR Reference₀ value 910-0 of the measurement report 900 of FIG. 9; the second segment 820-1 and Ref₁ 815-1 of FIG. 8 can correspond to the second L1-RSRP/SINR Reference₁ value 910-1 of the measurement report 900 of FIG. 9; and the third segment 820-2 and Ref₂ 815-2 of FIG. 8 can correspond to the third L1-RSRP/SINR Reference₂ value 910-2 of the measurement report 900 of FIG. 9.

The L1-RSRP/SINR Reference₀ value 910-0 is used as a common reference value for a differential quantization of the differential values Diff₀-Diff₃ determined between the respective RSRP/SINR measurements or predictions SSB #0_{Mcas}-SSB #3_{Mcas}, for SSBs #0- #3, and the L1-RSRP/SINR Reference₀ value 910-0 (e.g., which can be the same as Ref₀ 815-0 of FIG. 8). The L1-RSRP/SINR Reference₁ value 910-1 is used as a common reference value for a differential quantization of the differential values Diff₄-Diff₇ determined between the respective RSRP/SINR measurements or predictions SSB #4_{Mcas}-SSB #7_{Mcas}, for SSBs #4- #7, and the L1-RSRP/SINR Reference₁ value 910-1 (e.g., which can be the same as Ref₁ 815-1 of FIG. 8). The L1-RSRP/SINR Reference₂ value 910-2 is used as a common reference value for a differential quantization of the differential values Diff₈-Diff₁₁ determined between the respective RSRP/SINR measurements or predictions SSB #8_{Mcas}-SSB #11_{Mcas}, for SSBs #8- #11, and the L1-RSRP/SINR Reference₂ value 910-2 (e.g., which can be the same as Ref₂ 815-2 of FIG. 8).

In some cases, the selection of the value of N can be determined and indicated by the UE in the multi-segment CSI report 900, and the selection of whether the N^{th} segment should include a greater or lesser number of CMRs/CPRs than the 1^{st} through (N−1)^{th} segments can be pre-determined by a standards configuration or specification.

In some aspects, the number of bits used to quantize the respective L1-RSRP/SINRs determined for each CMR/CPR can be determined and reported or indicated as described above with respect to FIGS. 6 and 7.

In one illustrative example, the L1-RSRP/SINR information described above (e.g., beam-independent L1-RSRP/SINR common reference values and associated differential quantization values for measured L1-RSRP/SINRs for CMRs/CPRs) can be included in a CSI report, which may be a one-part CSI report or a two-part CSI report. In another illustrative example, the L1-RSRP/SINR information described above can be reported using MAC-CE or RRC-based feedback. In some cases, the L1-RSRP/SINR information described above can be reported using user-plane based L1-RSRP/SINR feedback. For instance, for data-collection, RRC or user-plane protocols could be used by the UE to indicate the L1-RSRP/SINR measurement or prediction information to a network entity for a plurality of CMRs or CPRs, respectively. Each packet can be generated by the UE to include L1-RSRPs or L1-SINRs from multiple measurement occasions, and may be transmitted using RRC or user-plane protocols rather than Physical Uplink Control Channel (PUCCH). Reporting L1-RSRP/SINR information using MAC-CE, RRC, or user-plane based L1-RSRP/SINR feedback can reduce the UL reporting overhead based on reducing the total package header bits needed (e.g., the multiple measurement occasions in a single packet share the same packet header, and do not include a header for each measurement occasion).

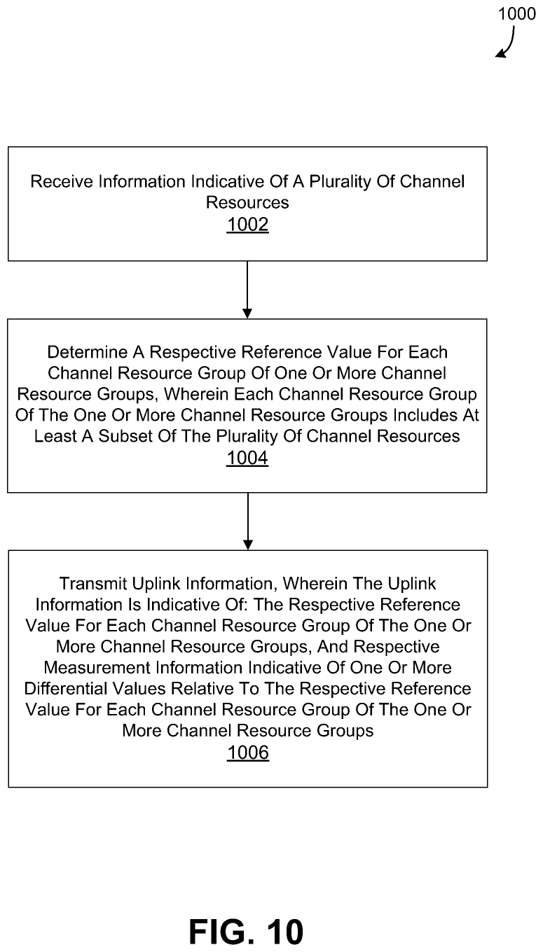

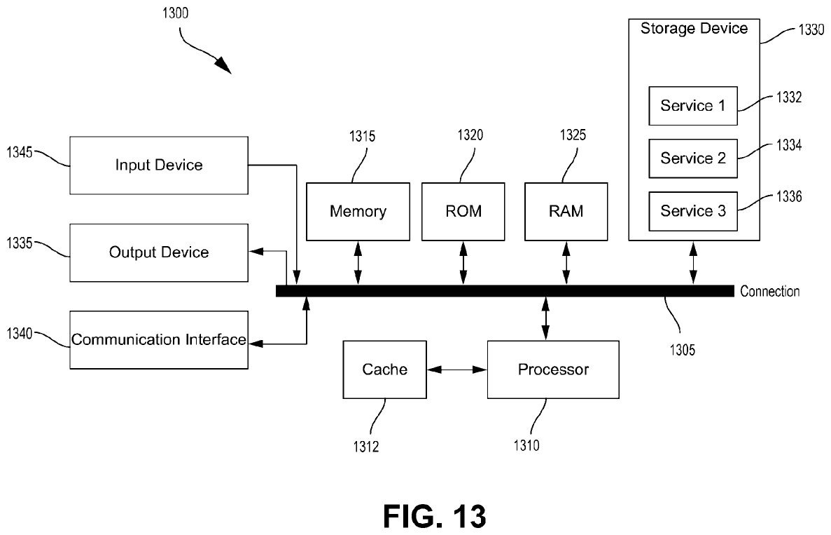

FIG. 10 is a flow diagram illustrating a process 1000 for performing wireless communications. The process 1000 can be performed by a component or system (e.g., a chipset) of a wireless device (e.g., one or more of UEs 104, 152, 164, 182, 190 of FIG. 1; UE 104 of FIG. 2; UE(s) 104 of FIG. 3; UE 407 of FIG. 4; computing system 1300 of FIG. 13; etc.). The wireless device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., processor 484 of FIG. 4, processor 1310 of FIG. 13, and/or other processor(s)). Further, the transmission and reception of signals by the wireless device in the process 1000 may be enabled, for example, by one or more antennas (e.g., antennas 252 of FIG. 2, antenna 487 of FIG. 4, etc.) and/or one or more transceivers (e.g., wireless transceiver(s) 478 of FIG. 4, etc.).

At block 1002, the process 1000 includes receiving information indicative of a plurality of channel resources. In some examples, the plurality of channel resources can be associated with a reference signal and can include one or more channel measurement resources (CMRs). In some examples, the plurality of channel resources can be channel prediction resources (CPRs). In some cases, each channel resource of the plurality of channel resources is a Synchronization Signal Block (SSB) or a Channel State Information (CSI) reference signal (CSI-RS). For instance, each channel resource can be an SSB the same as or similar to the SSB included in the downlink reference signals of FIG. 5, one or more of the SSBs 620 of FIG. 6, one or more of the SSBs 820-0, 820-1, 820-2 of FIG. 8, etc. In some examples, each channel resource can be a CSI-RS the same as or similar to the CSI-RS included in the downlink reference signals of FIG. 5.

In some examples, the plurality of channel resources comprises a plurality of channel measurement resources (CMRs) associated with the UE. In some cases, the plurality of channel resources comprises a plurality of channel prediction resources (CPRs) associated with the UE, wherein each CPR of the plurality of CPRs is a virtual resource for a corresponding reference signal received power (RSRP) prediction.

In some cases, the UE can receive, from the network entity, configuration information indicative of the plurality of channel resources and can receive at least one reference signal based on the configuration information and using the plurality of channel resources. For instance, the at least one reference signal can be received based on configuration information corresponding to CMRs (e.g., the at least one reference signal can be received using the configured CMRs corresponding to the configuration information).

In some examples, the UE can receive, from the network entity, a Media Access Control (MAC) Control Element (MAC-CE) indicative of the configuration information. In some cases, the UE can transmit the uplink information to the network entity based on a MAC-CE received from the network entity, wherein the configuration information is included in the MAC-CE. In some examples, the UE can receive, from the network entity, downlink control information (DCI) indicative of the configuration information.

At block 1004, the process 1000 includes determining a respective reference value for each channel resource group of one or more channel resource groups, wherein each channel resource group of the one or more channel resource groups includes at least a subset of the plurality of channel resources. For instance, the respective reference value can be the same as or similar to the reference value 615 of FIG. 6, determined for the channel resource group 620. In some examples, the respective reference value can be the same as or similar to the first reference value 815-0 of FIG. 8 determined for the first channel resource group 820-0, the first reference value 815-1 determined for the second channel resource group 820-1, or the third reference value 815-2 determined for the third channel resource group 820-2. In some cases, the respective reference value(s) can be the same as or similar to the L1-RSRP/SINR reference value 710 of FIG. 7 and/or one or more of the L1-RSRP/SINR reference value 910-0, 910-1, or 910-2 of FIG. 9.

In some cases, the one or more channel resource groups comprises a plurality of channel resource groups. For instance, the one or more channel resource groups can include the first channel resource group 820-0, second channel resource group 820-1, and third channel resource group 820-2 of FIG. 8. In some examples, a number of channel resource groups included in the plurality of channel resource groups corresponds to a number of channel resources included in the plurality of channel resources.

In some cases, the UE can receive, from the network entity, configuration information indicative of a number of channel resource groups included in the plurality of channel resource groups. For instance, the UE can determine the plurality of channel resource groups from the plurality of channel resources based on the configuration information. In some examples, the configuration information comprises one of a Radio Resource Control (RRC) message associated with a Channel State Information (CSI) report setting, a Media Access Control (MAC) Control Element (MAC-CE) associated with a CSI report from the UE to the network entity, or a CSI associated report configuration information.

In some examples, each channel resource group of the plurality of channel resource groups is associated with a different respective reference value. For instance, the respective reference value can be the same as or similar to the first reference value 815-0 of FIG. 8 determined for the first channel resource group 820-0, the first reference value 815-1 determined for the second channel resource group 820-1, or the third reference value 815-2 determined for the third channel resource group 820-2.

At block 1006, the process 1000 includes transmitting uplink information, wherein the uplink information is indicative of the respective reference value for each channel resource group of the one or more channel resource groups and respective measurement information indicative of one or more differential values relative to the respective reference value for each channel resource group of the one or more channel resource groups. For example, the uplink information can be the same as or similar to the uplink information 700 of FIG. 7 and/or the uplink information 900 of FIG. 9. In some cases, the uplink information can be transmitted to a network entity (e.g., such as a base station, gNB, etc.).

In some examples, uplink information is a Channel State Information (CSI) report. In some cases, the uplink information is included in one of Media Access Control (MAC) Control Element (MAC-CE), a Radio Resource Control (RRC) message, or a user-plane data packet.

In some cases, the uplink information is indicative of a number of channel resource groups included in the plurality of channel resource groups and a respective number of channel resources included in at least one channel resource group of the plurality of channel resource groups. In some examples, the number of channel resource groups and the respective number of channel resources are associated with a configured value, and wherein the uplink information is indicative of the configured value.

In some cases, the uplink information comprises a two-part Channel State Information (CSI) report. For instance, a first part of the two-part CSI report can include the configured value, and a second part of the two-part CSI report can include payload information. In some cases, the payload information can be indicative of the respective reference value for each channel resource group of the plurality of channel resource groups and the respective measurement information for each channel resource group of the plurality of channel resource groups. For instance, the payload can be indicative of one or more of the L1-RSRP/SINR references 710 of FIG. 7 and/or one or more of 910-0, 910-1, 910-2 of FIG. 9. In some cases, the uplink information 700 of FIGS. 7 and/or 900 of FIG. 9 can be included as a payload information of the second part of a two-part CSI report.

In some examples, the uplink information does not include channel measurement resource (CMR) identification (CMR-ID) information or channel prediction resource (CPR) identification (CPR-ID) information corresponding to the plurality of channel resources.

In some cases, the UE can transmit the respective reference value using a first configured quantity of bits and transmit each differential value using a second configured quantity of bits, wherein the second configured quantity of bits is less than the first configured quantity of bits. Each differential value of the one or more differential values can be associated with a corresponding channel resource of the plurality of channel resources. For instance, the first configured quantity of bits can be the same as or similar to B₀ of FIG. 7 and/or FIG. 9. In some cases, the second configured quantity of bits can be the same as or similar to B₁ of FIG. 7 and/or FIG. 9. In some cases, the differential values can be the same as or similar to the plurality of differential values Diff₀-Diff₁₁ of FIG. 6, the plurality of differential values 730 of FIG. 7, the plurality of differential values Diff₀-Diff₁₁ of FIG. 8, and/or the plurality of differential values 935 of FIG. 9.

In some cases, the UE can receive, from the network entity, configuration information indicative of the first configured quantity of bits and the second configured quantity of bits, and can transmit the uplink information the network entity based on the configuration information. For instance, the configuration information from the network entity can be indicative of the B₀ and/or B₁ values.

In some examples, the configuration information is further indicative of a plurality of respective bit-points. In some cases, the UE can determine the one or more differential values based on using the plurality of respective bit-points to perform differential quantization relative to the respective reference value for each channel resource group.

In some cases, the first configured quantity of bits (e.g., B₀), the second configured quantity of bits (e.g., B₁), and the plurality of respective bit-points can be associated with a pre-determined value, and the configuration information can be indicative of the pre-determined value. In some cases, the first configured quantity of bits, second configured quantity of bits, and plurality of respective bit-points can be associated with the same pre-determined value, or can be associated with respective different pre-determined values.

In some cases, the uplink information further includes a value indicative of the first configured quantity of bits, the second configured quantity of bits, and a plurality of respective bit-points. In some examples, the UE can determine the one or more differential values using the plurality of respective bit-points to perform differential quantization relative to the respective reference value for each channel resource group.

In some cases, the UE can determine one or more RSRP values or one or more SINR values for each channel resource group of the one or more channel resource groups, and can determine the respective reference value for each channel resource group based on the one or more RSRP values or the one or more SINR values corresponding to the channel resource group. In some cases, the respective reference value is greater than a first subset of the one or more RSRP values or the one or more SINR values, and the respective reference value is less than a second subset of the one or more RSRP values or the one or more SINR values.

In some examples, the respective measurement information is indicative of one or more differential reference signal received power (RSRP) values or one or more differential signal-to-interference-plus-noise ratio (SINR) values determined for each channel resource group of the one or more channel resource groups. In some cases, each differential RSRP value of the one or more RSRP values comprises a differential quantization, relative to a reference RSRP value, of a measured RSRP value corresponding to a particular channel resource of each channel resource group. In some cases, each differential SINR value of the one or more SINR values comprises a differential quantization, relative to a reference SINR value, of a measured SINR value corresponding to a particular channel resource of each channel resource group. In some instances, the UE can determine the one or more differential values based on differential quantization of respective reference signal measurement values relative to the respective reference value, wherein the differential quantization is based on a linear quantization step-size or a non-linear quantization step-size.

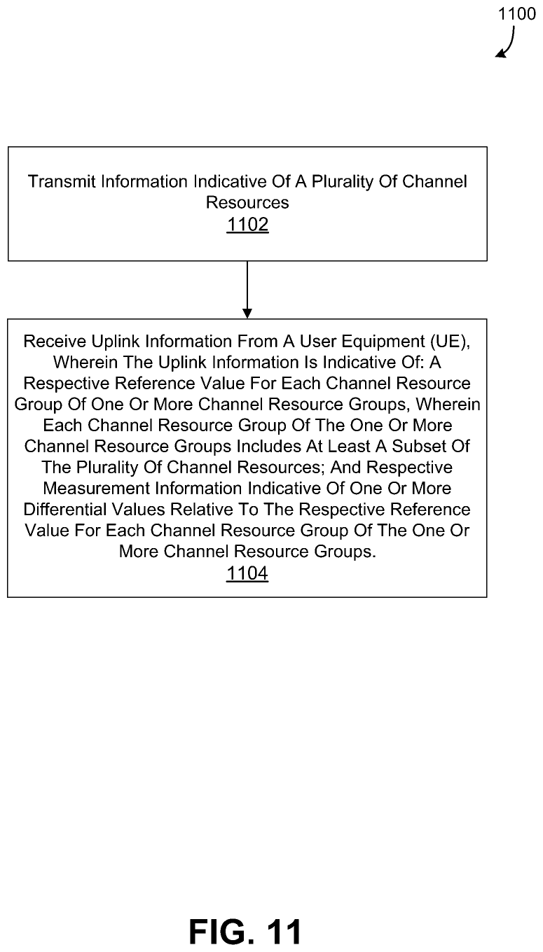

FIG. 11 is a flow diagram illustrating a process 1100 for performing wireless communications. The process 1100 can be performed by a component or system (e.g., a chipset) of a network entity (e.g., a base station, gNB, etc.). For instance, the network entity can be the same as or similar to one or more of the base stations 102 of FIG. 1, the mmW base station 180 of FIG. 1, the AP 150 of FIG. 1, the base station 102 of FIG. 2, one or more base stations or network entities of FIG. 3, the base stations 102 of FIG. 5, computing system 1300 of FIG. 13; etc.). The operations of the process 1100 may be implemented as software components that are executed and run on one or more processors (e.g., processor 484 of FIG. 4, processor 1310 of FIG. 13, and/or other processor(s)). Further, the transmission and reception of signals by the network entity in the process 1100 may be enabled, for example, by one or more antennas (e.g., antennas 252 of FIG. 2, antenna 487 of FIG. 4, etc.) and/or one or more transceivers (e.g., wireless transceiver(s) 478 of FIG. 4, etc.).

At block 1102, the process 1100 includes transmitting information indicative of a plurality of channel resources. In some examples, the plurality of channel resources can be associated with a reference signal and can include one or more channel measurement resources (CMRs). In some examples, the plurality of channel resources can be channel prediction resources (CPRs). In some cases, each channel resource of the plurality of channel resources is a Synchronization Signal Block (SSB) or a Channel State Information (CSI) reference signal (CSI-RS). For instance, each channel resource can be an SSB the same as or similar to the SSB included in the downlink reference signals of FIG. 5, one or more of the SSBs 620 of FIG. 6, one or more of the SSBs 820-0, 820-1, 820-2 of FIG. 8, etc. In some examples, each channel resource can be a CSI-RS the same as or similar to the CSI-RS included in the downlink reference signals of FIG. 5.

In some examples, the plurality of channel resources comprises a plurality of channel measurement resources (CMRs) associated with the network entity and/or associated with a user equipment (UE) that is itself associated with the network entity. For instance, the plurality of CMRs can be associated with at least one reference signal (e.g., downlink reference signal) associated with and/or transmitted by the network entity. In some cases, the plurality of channel resources comprises a plurality of channel prediction resources (CPRs) associated with the a UE that is itself associated with the network entity, wherein each CPR of the plurality of CPRs is a virtual resource for a corresponding reference signal received power (RSRP) prediction. The CPRs can be associated with a transmission by the network entity and/or can be associated with a virtual signal and no transmission by the network entity.

In some cases, the network entity can transmit, to the UE, configuration information indicative of the plurality of channel resources. The network entity can transmit at least one reference signal based on the configuration information and using the plurality of channel resources. For instance, the at least one reference signal can be transmitted based on configuration information corresponding to CMRs (e.g., the at least one reference signal can be transmitted using the configured CMRs corresponding to the configuration information).

In some examples, the network entity can transmit, to the UE, a Media Access Control (MAC) Control Element (MAC-CE) indicative of the configuration information. In some cases, the network entity can receive, from the UE, the uplink information based on a MAC-CE transmitted by the network entity, wherein the configuration information is included in the MAC-CE. In some examples, network entity can transmit to the UE downlink control information (DCI) indicative of the configuration information.

At block 1104, the process 1100 includes receiving uplink information from a user equipment (UE). For example, the uplink information can be indicative of a respective reference value for each channel resource group of one or more channel resource groups, wherein each channel resource group of the one or more channel resource groups includes at least a subset of the plurality of channel resources. In some cases, the uplink information can be further indicative of respective measurement information indicative of one or more differential values relative to the respective reference value for each channel resource group of the one or more channel resource groups.

For example, the uplink information can be the same as or similar to the uplink information 700 of FIG. 7 and/or the uplink information 900 of FIG. 9. In some cases, the uplink information can be received from a UE. In some examples, uplink information is a Channel State Information (CSI) report. In some cases, the uplink information is included in one of Media Access Control (MAC) Control Element (MAC-CE), a Radio Resource Control (RRC) message, or a user-plane data packet.

In some cases, the uplink information is indicative of a number of channel resource groups included in the plurality of channel resource groups and a respective number of channel resources included in at least one channel resource group of the plurality of channel resource groups. In some examples, the number of channel resource groups and the respective number of channel resources are associated with a configured value, wherein the uplink information is indicative of the configured value.

In some cases, the uplink information comprises a two-part Channel State Information (CSI) report. For instance, a first part of the two-part CSI report can include the configured value, and a second part of the two-part CSI report can include payload information. In some cases, the payload information can be indicative of the respective reference value for each channel resource group of the plurality of channel resource groups and the respective measurement information for each channel resource group of the plurality of channel resource groups. For instance, the payload can be indicative of one or more of the L1-RSRP/SINR references 710 of FIG. 7 and/or one or more of 910-0, 910-1, 910-2 of FIG. 9. In some cases, the uplink information 700 of FIGS. 7 and/or 900 of FIG. 9 can be included as a payload information of the second part of a two-part CSI report.

In some examples, the uplink information does not include channel measurement resource (CMR) identification (CMR-ID) information or channel prediction resource (CPR) identification (CPR-ID) information corresponding to the plurality of channel resources.

In some cases, the network entity can receive the respective reference value using a first configured quantity of bits and transmit each differential value using a second configured quantity of bits, wherein the second configured quantity of bits is less than the first configured quantity of bits. Each differential value of the one or more differential values can be associated with a corresponding channel resource of the plurality of channel resources. For instance, the first configured quantity of bits can be the same as or similar to B₀ of FIG. 7 and/or FIG. 9. In some cases, the second configured quantity of bits can be the same as or similar to B₁ of FIG. 7 and/or FIG. 9. In some cases, the differential values can be the same as or similar to the plurality of differential values Diff₀-Diff₁₁ of FIG. 6, the plurality of differential values 730 of FIG. 7, the plurality of differential values Diff₀-Diff₁₁ of FIG. 8, and/or the plurality of differential values 935 of FIG. 9.

In some cases, network entity can transmit to the UE configuration information indicative of the first configured quantity of bits and the second configured quantity of bits, and can receive from the UE uplink information based on the configuration information. For instance, the configuration information transmitted by the network entity can be indicative of the B₀ and/or B₁ values.

In some examples, the configuration information is further indicative of a plurality of respective bit-points. In some cases, the UE can determine the one or more differential values based on using the plurality of respective bit-points to perform differential quantization relative to the respective reference value for each channel resource group.

In some cases, the first configured quantity of bits (e.g., B₀), the second configured quantity of bits (e.g., B₁), and the plurality of respective bit-points can be associated with a pre-determined value, and the configuration information can be indicative of the pre-determined value. In some cases, the first configured quantity of bits, second configured quantity of bits, and plurality of respective bit-points can be associated with the same pre-determined value, or can be associated with respective different pre-determined values. In some cases, the uplink information further includes a value indicative of the first configured quantity of bits, the second configured quantity of bits, and a plurality of respective bit-points. In some examples, the UE can determine the one or more differential values using the plurality of respective bit-points to perform differential quantization relative to the respective reference value for each channel resource group. In some cases, the UE can determine one or more RSRP values or one or more SINR values for each channel resource group of the one or more channel resource groups, and can determine the respective reference value for each channel resource group based on the one or more RSRP values or the one or more SINR values corresponding to the channel resource group. In some cases, the respective reference value is greater than a first subset of the one or more RSRP values or the one or more SINR values, and the respective reference value is less than a second subset of the one or more RSRP values or the one or more SINR values.

In some examples, the respective measurement information is indicative of one or more differential reference signal received power (RSRP) values or one or more differential signal-to-interference-plus-noise ratio (SINR) values determined for each channel resource group of the one or more channel resource groups. In some cases, each differential RSRP value of the one or more RSRP values comprises a differential quantization, relative to a reference RSRP value, of a measured RSRP value corresponding to a particular channel resource of each channel resource group. In some cases, each differential SINR value of the one or more SINR values comprises a differential quantization, relative to a reference SINR value, of a measured SINR value corresponding to a particular channel resource of each channel resource group. In some instances, the UE can determine the one or more differential values based on differential quantization of respective reference signal measurement values relative to the respective reference value, wherein the differential quantization is based on a linear quantization step-size or a non-linear quantization step-size.

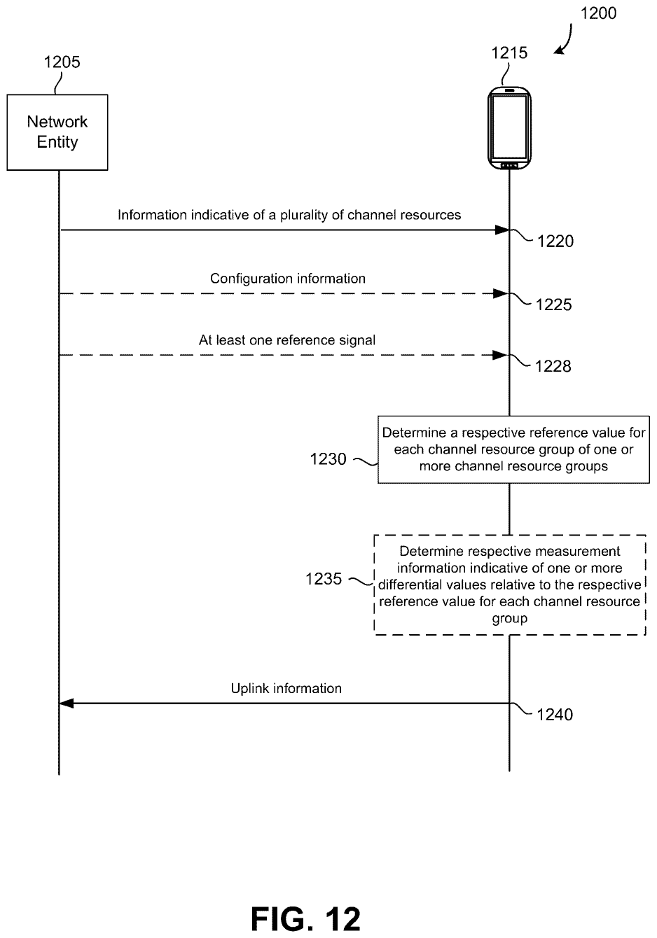

FIG. 12 is a signaling diagram corresponding to a process for wireless communication 1200 that can be performed between a network entity 1205 and a UE 1215. In some cases, the network entity 1205 can be the same as or similar to a network entity associated with performing process 1100 of FIG. 11 and/or the UE 1215 can be the same as or similar to a UE associated with performing process 1000 of FIG. 10.

In some examples, the network entity 1205 can transmit information 1220 indicative of a plurality of channel resources to the UE 1215. The UE 1215 can receive the information 1220 indicative of the plurality of channel resources from the network entity 1205. The information 1220 indicative of the plurality of channel resources can be indicative of a plurality of CMRs or a plurality of CPRs.

In some cases, the network entity 1205 can transmit configuration information 1225 to the UE 1215. The UE 1215 can receive configuration information 1225 from the network entity 1205. The configuration information can be indicative of one or more parameters for a measurement report associated with the plurality of channel resources corresponding to the channel resource information 1220.

In some cases, the network entity 1205 can transmit at least one reference signal 1228 to the UE 1215. The UE 1215 can receive at least one reference signal 1228 from the network entity 1205. For instance, the information indicative of a plurality of channel resources 1220 can correspond to a plurality of CMRs, and the network entity 1205 can transmit the at least one reference signal 1228 using the plurality of CMRs.

At block 1230, the UE 1215 can determine a respective reference value for each channel resource group of one or more channel resource groups. In some case, block 1230 can be the same as or similar to block 1004 of FIG. 10.

In some cases, at block 1235, the UE 1215 can determine a respective measurement information indicative of one or more differential values relative to the respective reference value for each channel resource group. For instance, block 1235 can be the same as or similar to block 1006 of FIG. 10 and/or block 1235 can be included in block 1006 of FIG. 10. Each differential value of the one or more differential values can be associated with a corresponding channel resource of the plurality of channel resources. For instance, the first configured quantity of bits can be the same as or similar to B₀ of FIG. 7 and/or FIG. 9. In some cases, the second configured quantity of bits can be the same as or similar to B₁ of FIG. 7 and/or FIG. 9. In some cases, the differential values can be the same as or similar to the plurality of differential values Diff₀-Diff₁₁ of FIG. 6, the plurality of differential values 730 of FIG. 7, the plurality of differential values Diff₀-Diff₁₁ of FIG. 8, and/or the plurality of differential values 935 of FIG. 9.

In some examples, the UE 1215 can transmit uplink information 1240 to the network entity 1205. The network entity 1205 can receive uplink information 1240 from the UE 1215. In some cases, the uplink information 1240 can be the same as or similar to the uplink information described above corresponding to block 1006 of FIG. 10 and/or block 1104 of FIG. 11.

FIG. 13 is a diagram illustrating an example of a system for implementing certain aspects of the present technology. In particular, FIG. 13 illustrates an example of computing system, which may be for example any computing device making up internal computing system, a remote computing system, a camera, or any component thereof in which the components of the system are in communication with each other using connection 1305. Connection 1305 may be a physical connection using a bus, or a direct connection into processor 1310, such as in a chipset architecture. Connection 1305 may also be a virtual connection, networked connection, or logical connection.

In some aspects and examples, computing system 1300 is a distributed system in which the functions described in this disclosure may be distributed within a datacenter, multiple data centers, a peer network, etc. In some aspects and examples, one or more of the described system components represents many such components each performing some or all of the function for which the component is described. In some aspects and examples, the components may be physical or virtual devices.

Example system 1300 includes at least one processing unit (CPU or processor) 1310 and connection 1305 that communicatively couples various system components including system memory 1315, such as read-only memory (ROM) 1320 and random access memory (RAM) 1325 to processor 1310. Computing system 1300 may include a cache 1312 of high-speed memory connected directly with, in close proximity to, or integrated as part of processor 1310.

Processor 1310 may include any general purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which may represent any number of input mechanisms, such as a microphone for speech, a touch-sensitive screen for gesture or graphical input, keyboard, mouse, motion input, speech, etc. Computing system 1300 may also include output device 1335, which may be one or more of a number of output mechanisms. In some instances, multimodal systems may enable a user to provide multiple types of input/output to communicate with computing system 1300.

Computing system 1300 may include communications interface 1340, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 may include software services, servers, services, etc., that when the code that defines such software is executed by the processor 1310, it causes the system to perform a function. In some aspects and examples, a hardware service that performs a particular function may include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects and examples may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects, the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one processor configured to,” “at least one processor being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Illustrative aspects of the disclosure include:
Aspect 1. An apparatus of a user equipment (UE) for wireless communication, comprising: at least one memory; and at least one processor coupled to the at least one memory, wherein the at least one processor is configured to: receive information indicative of a plurality of channel resources; determine a respective reference value for each channel resource group of one or more channel resource groups, wherein each channel resource group of the one or more channel resource groups includes at least a subset of the plurality of channel resources; and transmit uplink information to a network entity, wherein the uplink information is indicative of: the respective reference value for each channel resource group of the one or more channel resource groups; and respective measurement information indicative of one or more differential values relative to the respective reference value for each channel resource group of the one or more channel resource groups.
Aspect 2. The apparatus of Aspect 1, wherein the respective measurement information is indicative of one or more differential reference signal received power (RSRP) values or one or more differential signal-to-interference-plus-noise ratio (SINR) values determined for each channel resource group of the one or more channel resource groups.
Aspect 3. The apparatus of Aspect 2, wherein: each differential RSRP value of the one or more RSRP values comprises a differential quantization, relative to a reference RSRP value, of a measured RSRP value corresponding to a particular channel resource of each channel resource group; or each differential SINR value of the one or more SINR values comprises a differential quantization, relative to a reference SINR value, of a measured SINR value corresponding to a particular channel resource of each channel resource group.
Aspect 4. The apparatus of any of Aspects 2 to 3, wherein the at least one processor is further configured to: determine the one or more RSRP values or the one or more SINR values for each channel resource group of the one or more channel resource groups; and determine the respective reference value based on the one or more RSRP values or the one or more SINR values.
Aspect 5. The apparatus of Aspect 4, wherein: the respective reference value is greater than a first subset of the one or more RSRP values or the one or more SINR values; and the respective reference value is less than a second subset of the one or more RSRP values or the one or more SINR values.
Aspect 6. The apparatus of any of Aspects 1 to 5, wherein the uplink information does not include channel measurement resource (CMR) identification (CMR-ID) information or channel prediction resource (CPR) identification (CPR-ID) information corresponding to the plurality of channel resources.
Aspect 7. The apparatus of any of Aspects 1 to 6, wherein: the at least one processor is configured to transmit the respective reference value using a first configured quantity of bits; the at least one processor is configured to transmit each differential value using a second configured quantity of bits, wherein the second configured quantity of bits is less than the first configured quantity of bits; and each differential value of the one or more differential values is associated with a corresponding channel resource of the plurality of channel resources.
Aspect 8. The apparatus of Aspect 7, wherein the at least one processor is further configured to: receive, from the network entity, configuration information indicative of the first configured quantity of bits and the second configured quantity of bits; and transmit the uplink information the network entity based on the configuration information.
Aspect 9. The apparatus of Aspect 8, wherein: the configuration information is further indicative of a plurality of respective bit-points; and the at least one processor is configured to determine the one or more differential values using the plurality of respective bit-points to perform differential quantization relative to the respective reference value for each channel resource group.
Aspect 10. The apparatus of Aspect 9, wherein: the first configured quantity of bits, the second configured quantity of bits, and the plurality of respective bit-points are associated with a pre-determined value; and the configuration information is indicative of the pre-determined value.
Aspect 11. The apparatus of any of Aspects 7 to 10, wherein: the uplink information further includes a value indicative of the first configured quantity of bits, the second configured quantity of bits, and a plurality of respective bit-points; and the at least one processor is configured to determine the one or more differential values using the plurality of respective bit-points to perform differential quantization relative to the respective reference value for each channel resource group.
Aspect 12. The apparatus of any of Aspects 1 to 11, wherein the at least one processor is configured to determine the one or more differential values based on differential quantization of respective reference signal measurement values relative to the respective reference value, and wherein the differential quantization is based on a linear quantization step-size or a non-linear quantization step-size.
Aspect 13. The apparatus of any of Aspects 1 to 12, wherein: the one or more channel resource groups comprises a plurality of channel resource groups.
Aspect 14. The apparatus of Aspect 13, wherein a number of channel resource groups included in the plurality of channel resource groups corresponds to a number of channel resources included in the plurality of channel resources.
Aspect 15. The apparatus of any of Aspects 13 to 14, wherein the at least one processor is further configured to: receive, from the network entity, configuration information indicative of a number of channel resource groups included in the plurality of channel resource groups; and determine the plurality of channel resource groups from the plurality of channel resources based on the configuration information.
Aspect 16. The apparatus of Aspect 15, wherein the configuration information comprises one of a Radio Resource Control (RRC) message associated with a Channel State Information (CSI) report setting, a Media Access Control (MAC) Control Element (MAC-CE) associated with a CSI report from the UE to the network entity, or a CSI associated report configuration information.
Aspect 17. The apparatus of any of Aspects 13 to 16, wherein the uplink information is indicative of: a number of channel resource groups included in the plurality of channel resource groups; and a respective number of channel resources included in at least one channel resource group of the plurality of channel resource groups.
Aspect 18. The apparatus of Aspect 17, wherein the number of channel resource groups and the respective number of channel resources are associated with a configured value, and wherein the uplink information is indicative of the configured value.
Aspect 19. The apparatus of Aspect 18, wherein: the uplink information comprises a two-part Channel State Information (CSI) report; a first part of the two-part CSI report includes the pre-determined value; and a second part of the two-part CSI report includes payload information, the payload information indicative of: the respective reference value for each channel resource group of the plurality of channel resource groups; and the respective measurement information for each channel resource group of the plurality of channel resource groups.
Aspect 20. The apparatus of any of Aspects 13 to 19, wherein each channel resource group of the plurality of channel resource groups is associated with a different respective reference value.
Aspect 21. The apparatus of any of Aspects 1 to 20, wherein the uplink information is a Channel State Information (CSI) report.
Aspect 22. The apparatus of any of Aspects 1 to 21, wherein the uplink information is included in one of Media Access Control (MAC) Control Element (MAC-CE), a Radio Resource Control (RRC) message, or a user-plane data packet.
Aspect 23. The apparatus of any of Aspects 1 to 22, wherein each channel resource of the plurality of channel resources is a Synchronization Signal Block (SSB) or a Channel State Information (CSI) reference signal (CSI-RS).
Aspect 24. The apparatus of any of Aspects 1 to 23, wherein the plurality of channel resources comprises a plurality of channel measurement resources (CMRs) associated with the UE.
Aspect 25. The apparatus of any of Aspects 1 to 24, wherein the plurality of channel resources comprises a plurality of channel prediction resources (CPRs) associated with the UE, and wherein each CPR of the plurality of CPRs is a virtual resource for a corresponding reference signal received power (RSRP) prediction.
Aspect 26. The apparatus of any of Aspects 1 to 25, wherein the at least one processor is further configured to: receive, from the network entity, configuration information indicative of the plurality of channel resources; and receive at least one reference signal based on the configuration information and using the plurality of channel resources.
Aspect 27. The apparatus of Aspect 26, wherein the at least one processor is further configured to: receive, from the network entity, a Media Access Control (MAC) Control Element (MAC-CE) indicative of the configuration information.
Aspect 28. The apparatus of any of Aspects 1 to 27, wherein: the at least one processor is configured to transmit the uplink information to the network entity based on a Media Access Control (MAC) Control Element (MAC-CE) received from the network entity; and the configuration information is included in the MAC-CE.
Aspect 29. The apparatus of Aspect 28, wherein the at least one processor is further configured to: receive, from the network entity, downlink control information (DCI) indicative of the configuration information.
Aspect 30. A method of wireless communications performed by a user equipment (UE), the method comprising: receiving information indicative of a plurality of channel resources; determining a respective reference value for each channel resource group of one or more channel resource groups, wherein each channel resource group of the one or more channel resource groups includes at least a subset of the plurality of channel resources; and transmitting uplink information to a network entity, wherein the uplink information is indicative of: the respective reference value for each channel resource group of the one or more channel resource groups; and respective measurement information indicative of one or more differential values relative to the respective reference value for each channel resource group of the one or more channel resource groups.
Aspect 31. The method of Aspect 30, wherein the respective measurement information is indicative of one or more differential reference signal received power (RSRP) values or one or more differential signal-to-interference-plus-noise ratio (SINR) values determined for each channel resource group of the one or more channel resource groups.
Aspect 32. The method of Aspect 31, wherein: each differential RSRP value of the one or more RSRP values comprises a differential quantization, relative to a reference RSRP value, of a measured RSRP value corresponding to a particular channel resource of each channel resource group; or each differential SINR value of the one or more SINR values comprises a differential quantization, relative to a reference SINR value, of a measured SINR value corresponding to a particular channel resource of each channel resource group.
Aspect 33. The method of any of Aspects 31 to 32, further comprising: determining the one or more RSRP values or the one or more SINR values for each channel resource group of the one or more channel resource groups; and determining the respective reference value based on the one or more RSRP values or the one or more SINR values.
Aspect 34. The method of Aspect 33, wherein: the respective reference value is greater than a first subset of the one or more RSRP values or the one or more SINR values; and the respective reference value is less than a second subset of the one or more RSRP values or the one or more SINR values.
Aspect 35. The method of any of Aspects 30 to 34, wherein the uplink information does not include channel measurement resource (CMR) identification (CMR-ID) information or channel prediction resource (CPR) identification (CPR-ID) information corresponding to the plurality of channel resources.
Aspect 36. The method of any of Aspects 30 to 35, further comprising: transmitting the respective reference value using a first configured quantity of bits; and transmitting each differential value using a second configured quantity of bits, wherein the second configured quantity of bits is less than the first configured quantity of bits; wherein each differential value of the one or more differential values is associated with a corresponding channel resource of the plurality of channel resources.
Aspect 37. The method of Aspect 36, further comprising: receiving, from the network entity, configuration information indicative of the first configured quantity of bits and the second configured quantity of bits; and transmitting the uplink information the network entity based on the configuration information.
Aspect 38. The method of Aspect 37, wherein: the configuration information is further indicative of a plurality of respective bit-points; and the one or more differential values are determined based on using the plurality of respective bit-points to perform differential quantization relative to the respective reference value for each channel resource group.
Aspect 39. The method of Aspect 38, wherein: the first configured quantity of bits, the second configured quantity of bits, and the plurality of respective bit-points are associated with a pre-determined value; and the configuration information is indicative of the pre-determined value.
Aspect 40. The method of any of Aspects 36 to 39, wherein: the uplink information further includes a value indicative of the first configured quantity of bits, the second configured quantity of bits, and a plurality of respective bit-points; and the one or more differential values are determined based on using the plurality of respective bit-points to perform differential quantization relative to the respective reference value for each channel resource group.
Aspect 41. The method of any of Aspects 30 to 40, further comprising determining the one or more differential values based on differential quantization of respective reference signal measurement values relative to the respective reference value, and wherein the differential quantization is based on a linear quantization step-size or a non-linear quantization step-size.
Aspect 42. The method of any of Aspects 30 to 41, wherein: the one or more channel resource groups comprises a plurality of channel resource groups.
Aspect 43. The method of Aspect 42, wherein a number of channel resource groups included in the plurality of channel resource groups corresponds to a number of channel resources included in the plurality of channel resources.
Aspect 44. The method of any of Aspects 42 to 43, further comprising: receiving, from the network entity, configuration information indicative of a number of channel resource groups included in the plurality of channel resource groups; and determining the plurality of channel resource groups from the plurality of channel resources based on the configuration information.
Aspect 45. The method of Aspect 44, wherein the configuration information comprises one of a Radio Resource Control (RRC) message associated with a Channel State Information (CSI) report setting, a Media Access Control (MAC) Control Element (MAC-CE) associated with a CSI report from the UE to the network entity, or a CSI associated report configuration information.
Aspect 46. The method of any of Aspects 42 to 45, wherein the uplink information is indicative of: a number of channel resource groups included in the plurality of channel resource groups; and a respective number of channel resources included in at least one channel resource group of the plurality of channel resource groups.
Aspect 47. The method of Aspect 46, wherein the number of channel resource groups and the respective number of channel resources are associated with a configured value, and wherein the uplink information is indicative of the configured value.
Aspect 48. The method of Aspect 47, wherein: the uplink information comprises a two-part Channel State Information (CSI) report; a first part of the two-part CSI report includes the pre-determined value; and a second part of the two-part CSI report includes payload information, the payload information indicative of: the respective reference value for each channel resource group of the plurality of channel resource groups; and the respective measurement information for each channel resource group of the plurality of channel resource groups.
Aspect 49. The method of any of Aspects 42 to 48, wherein each channel resource group of the plurality of channel resource groups is associated with a different respective reference value.
Aspect 50. The method of any of Aspects 30 to 49, wherein the uplink information is a Channel State Information (CSI) report.
Aspect 51. The method of any of Aspects 30 to 50, wherein the uplink information is included in one of Media Access Control (MAC) Control Element (MAC-CE), a Radio Resource Control (RRC) message, or a user-plane data packet.
Aspect 52. The method of any of Aspects 30 to 51, wherein each channel resource of the plurality of channel resources is a Synchronization Signal Block (SSB) or a Channel State Information (CSI) reference signal (CSI-RS).
Aspect 53. The method of any of Aspects 30 to 52, wherein the plurality of channel resources comprises a plurality of channel measurement resources (CMRs) associated with the UE.
Aspect 54. The method of any of Aspects 30 to 53, wherein the plurality of channel resources comprises a plurality of channel prediction resources (CPRs) associated with the UE, and wherein each CPR of the plurality of CPRs is a virtual resource for a corresponding reference signal received power (RSRP) prediction.
Aspect 55. The method of any of Aspects 30 to 54, further comprising: receiving, from the network entity, configuration information indicative of the plurality of channel resources; and receiving at least one reference signal based on the configuration information and using the plurality of channel resources.
Aspect 56. The method of Aspect 55, further comprising: receiving, from the network entity, a Media Access Control (MAC) Control Element (MAC-CE) indicative of the configuration information.
Aspect 57. A method for wireless communications comprising performing operations according to any of Aspects 1 to 29.
Aspect 58. A non-transitory computer-readable storage medium comprising instructions stored thereon which, when executed by at least one processor, causes the at least one processor to perform operations according to any of Aspects 1-29.
Aspect 59. A non-transitory computer-readable storage medium comprising instructions stored thereon which, when executed by at least one processor, causes the at least one processor to perform operations according to any of Aspects 30 to 56.
Aspect 60. An apparatus for wireless communications comprising one or more means for performing operations according to any of Aspects 30 to 56.
Aspect 61. A method of wireless communication performed by a network entity, the method comprising: transmitting information indicative of a plurality of channel resources; and receiving uplink information from a user equipment (UE), wherein the uplink information is indicative of: a respective reference value for each channel resource group of one or more channel resource groups, wherein each channel resource group of the one or more channel resource groups includes at least a subset of the plurality of channel resources; and respective measurement information indicative of one or more differential values relative to the respective reference value for each channel resource group of the one or more channel resource groups.
Aspect 62: An apparatus of a network entity for wireless communication, the apparatus comprising: at least one memory; and at least one processor coupled to the at least one memory and configured to: transmit information indicative of a plurality of channel resources; and receive uplink information from a user equipment (UE), wherein the uplink information is indicative of: a respective reference value for each channel resource group of one or more channel resource groups, wherein each channel resource group of the one or more channel resource groups includes at least a subset of the plurality of channel resources; and respective measurement information indicative of one or more differential values relative to the respective reference value for each channel resource group of the one or more channel resource groups.
Aspect 63: A non-transitory computer-readable storage medium comprising instructions stored thereon which, when executed by at least one processor, causes the at least one processor to: transmit information indicative of a plurality of channel resources; and receive uplink information from a user equipment (UE), wherein the uplink information is indicative of: a respective reference value for each channel resource group of one or more channel resource groups, wherein each channel resource group of the one or more channel resource groups includes at least a subset of the plurality of channel resources; and respective measurement information indicative of one or more differential values relative to the respective reference value for each channel resource group of the one or more channel resource groups.
Aspect 64: An apparatus for wireless communication, the apparatus comprising: means for transmitting information indicative of a plurality of channel resources; and means for receiving uplink information from a user equipment (UE), wherein the uplink information is indicative of: a respective reference value for each channel resource group of one or more channel resource groups, wherein each channel resource group of the one or more channel resource groups includes at least a subset of the plurality of channel resources; and respective measurement information indicative of one or more differential values relative to the respective reference value for each channel resource group of the one or more channel resource groups.

1. An apparatus of a user equipment (UE) for wireless communication, comprising:
at least one memory; and
at least one processor coupled to the at least one memory, wherein the at least one processor is configured to:
receive information indicative of a plurality of channel resources;
determine a respective reference value for each channel resource group of one or more channel resource groups, wherein each channel resource group of the one or more channel resource groups includes at least a subset of the plurality of channel resources; and
transmit uplink information, wherein the uplink information is indicative of:
the respective reference value for each channel resource group of the one or more channel resource groups; and
respective measurement information indicative of one or more differential values relative to the respective reference value for each channel resource group of the one or more channel resource groups.

2. The apparatus of claim 1, wherein the respective measurement information is indicative of one or more differential reference signal received power (RSRP) values or one or more differential signal-to-interference-plus-noise ratio (SINR) values determined for each channel resource group of the one or more channel resource groups.

3. The apparatus of claim 2, wherein:
each differential RSRP value of the one or more RSRP values comprises a differential quantization, relative to a reference RSRP value, of a measured RSRP value corresponding to a particular channel resource of each channel resource group; or
each differential SINR value of the one or more SINR values comprises a differential quantization, relative to a reference SINR value, of a measured SINR value corresponding to a particular channel resource of each channel resource group.

4. The apparatus of claim 2, wherein the at least one processor is further configured to:
determine the one or more RSRP values or the one or more SINR values for each channel resource group of the one or more channel resource groups; and
determine the respective reference value based on the one or more RSRP values or the one or more SINR values.

5. The apparatus of claim 4, wherein:
the respective reference value is greater than a first subset of the one or more RSRP values or the one or more SINR values; and
the respective reference value is less than a second subset of the one or more RSRP values or the one or more SINR values.

6. The apparatus of claim 1, wherein the uplink information does not include channel measurement resource (CMR) identification (CMR-ID) information or channel prediction resource (CPR) identification (CPR-ID) information corresponding to the plurality of channel resources.

7. The apparatus of claim 1, wherein:
the at least one processor is configured to transmit the respective reference value using a first configured quantity of bits;
the at least one processor is configured to transmit each differential value using a second configured quantity of bits, wherein the second configured quantity of bits is less than the first configured quantity of bits; and
each differential value of the one or more differential values is associated with a corresponding channel resource of the plurality of channel resources.

8. The apparatus of claim 7, wherein the at least one processor is further configured to:
receive, from a network entity, configuration information indicative of the first configured quantity of bits and the second configured quantity of bits; and
transmit the uplink information to the network entity based on the configuration information.

9. The apparatus of claim 8, wherein:
the configuration information is further indicative of a plurality of respective bit-points; and
the at least one processor is configured to determine the one or more differential values using the plurality of respective bit-points to perform differential quantization relative to the respective reference value for each channel resource group.

10. The apparatus of claim 9, wherein:
the first configured quantity of bits, the second configured quantity of bits, and the plurality of respective bit-points are associated with a pre-determined value; and
the configuration information is indicative of the pre-determined value.

11. The apparatus of claim 7, wherein:
the uplink information further includes a value indicative of the first configured quantity of bits, the second configured quantity of bits, and a plurality of respective bit-points; and
the at least one processor is configured to determine the one or more differential values using the plurality of respective bit-points to perform differential quantization relative to the respective reference value for each channel resource group.

12. The apparatus of claim 1, wherein the at least one processor is configured to transmit the uplink information to a network entity.

13. The apparatus of claim 1, wherein the at least one processor is configured to determine the one or more differential values based on differential quantization of respective reference signal measurement values relative to the respective reference value, and wherein the differential quantization is based on a linear quantization step-size or a non-linear quantization step-size.

14. The apparatus of claim 1, wherein:
the one or more channel resource groups comprises a plurality of channel resource groups.

15. The apparatus of claim 14, wherein a number of channel resource groups included in the plurality of channel resource groups corresponds to a number of channel resources included in the plurality of channel resources.

16. The apparatus of claim 14, wherein the at least one processor is further configured to:
receive, from a network entity, configuration information indicative of a number of channel resource groups included in the plurality of channel resource groups; and
determine the plurality of channel resource groups from the plurality of channel resources based on the configuration information.

17. The apparatus of claim 16, wherein the configuration information comprises one of a Radio Resource Control (RRC) message associated with a Channel State Information (CSI) report setting, a Media Access Control (MAC) Control Element (MAC-CE) associated with a CSI report from the UE to a network entity, or a CSI associated report configuration information.

18. The apparatus of claim 14, wherein the uplink information is indicative of:
a number of channel resource groups included in the plurality of channel resource groups; and
a respective number of channel resources included in at least one channel resource group of the plurality of channel resource groups.

19-28. (canceled)

29. A method of wireless communications performed by a user equipment (UE), the method comprising:
receiving information indicative of a plurality of channel resources;
determining a respective reference value for each channel resource group of one or more channel resource groups, wherein each channel resource group of the one or more channel resource groups includes at least a subset of the plurality of channel resources; and
transmitting uplink information, wherein the uplink information is indicative of:
the respective reference value for each channel resource group of the one or more channel resource groups; and
respective measurement information indicative of one or more differential values relative to the respective reference value for each channel resource group of the one or more channel resource groups.

30. The method of claim 29, wherein:
the respective measurement information is indicative of one or more differential reference signal received power (RSRP) values or one or more differential signal-to-interference-plus-noise ratio (SINR) values determined for each channel resource group of the one or more channel resource groups; and
each differential RSRP value of the one or more RSRP values comprises a differential quantization, relative to a reference RSRP value, of a measured RSRP value corresponding to a particular channel resource of each channel resource group; or
each differential SINR value of the one or more SINR values comprises a differential quantization, relative to a reference SINR value, of a measured SINR value corresponding to a particular channel resource of each channel resource group.
